(19) United States
(12) Patent Application Publication
(10) Pub. No.: US 2025/0356100 A1
(43) Pub. Date: Nov. 20, 2025

(54) ITERATIVE PARASITICS EXTRACTION FOR INTERCONNECT SEGMENTS IN DIFFERENT TILES

(71) Applicant: D2S, Inc., San Jose, CA (US)

(72) Inventor: Donald Oriordan, Sunnyvale, CA (US)

(21) Appl. No.: 19/033,436

(22) Filed: Jan. 21, 2025

Related U.S. Application Data
(60) Provisional application No. 63/649,300, filed on May 17, 2024.
(60) Provisional application No. 63/676,296, filed on Jul. 26, 2024.

(51) Int. Cl. G06F 30/392; G06F 17/11; G06F 30/27; G06F 111/10; G06F 119/06

(52) U.S. Cl. CPC G06F 30/392; G06F 17/11; G06F 30/27; G06F 2111/10; G06F 2119/06

(57) ABSTRACT

Some embodiments provide a method for calculating parasitic capacitance for an IC design layout. The method iteratively selects a core region and a plurality of halo regions neighboring the core region. For each interconnect segment located in the core, the method computes a halo capacitance value representing parasitic capacitance exerted on the interconnect segment by a particular neighboring segment in a particular neighboring halo region that depends on the particular neighboring segment in the particular neighboring halo region in addition to at least one additional neighboring interconnect segment in another halo region. To account for first and second interconnect segments in neighboring regions having different computed halo capacitance values with respect to each other, the method computes a single capacitance value from the first and second computed halo capacitance values and uses the single capacitance value to represent the parasitic capacitance exerted between the first and second interconnect segments.

### BACKGROUND

In electronic design automation (EDA), parasitic extraction refers to the calculation of the parasitic effects in both the designed devices and the required wiring interconnects of an electronic circuit. These parasitic effects include parasitic capacitances, parasitic resistances, and parasitic inductances, which are commonly called parasitic devices, parasitic components, or simply parasitics.

A primary purpose of parasitic extraction tools is to create an accurate analog model of the circuit so that detailed simulations can emulate actual digital and analog circuit responses. Digital circuit responses are often used to populate databases for signal delay and loading calculation such as timing analysis, power analysis, circuit simulation, and signal integrity analysis. Analog circuits are often run in detailed test benches to indicate if the extra extracted parasitics will still allow the designed circuit to function.

Interconnect capacitance can be calculated by giving an extraction tool information including (1) a top view of the design layout in the form of input polygons on a set of layers, (2) a mapping to a set of devices and pins (e.g., from a layout versus schematic (LVS) check), and (3) a cross-sectional representation of these layers. This information is used to create a set of layout wires with added capacitors where indicated by the input polygons and cross-sectional structure. An output netlist includes the same set of input nets as an input design netlist and adds parasitic capacitor devices between these nets.

Existing extraction tools fall into several categories. Field solvers are one type of tool that provides physically accurate solutions. These solvers calculate electromagnetic parameters by directly solving Maxwell's equations. Due to the high calculation burden of these calculations, field solvers are currently only applicable to very small designs or to parts of designs. On the other hand, approximate solutions that use pattern matching techniques are currently the only feasible approach to extract parasitics for complete modern IC designs. However, these approximate solutions are only applicable to IC designs following certain layout techniques or structures (e.g., Manhattan routed wires). Combination approaches exist that try to combine the best of both of these options. Such combination approaches offer fast but approximate solutions for some portions of the design where possible and slow-but-accurate solutions for the remaining portions of the design.

FIG. 1 illustrates an IC design 100 with omni-directional routes on multiple circuit layers. Such an IC design 100 presents significant challenges to existing capacitance extraction tools because the omni-directional routes are not constrained to run at multiples of 0, 45 or 90 degrees. A router for such an IC design 100 has freedom to run these routes in essentially any direction. The approximate solutions approach (e.g., a fast 2.5-dimensional (2.5D) model-based approach) mentioned above fails for such omni-directional designs, as these tools work on the assumption that the interconnect match a relatively small, discrete number of metal overlap patterns (an assumption that holds for, e.g., Manhattan routing).

The field solvers (e.g., FastCAP and FastCAP2) could theoretically be applied to such an omni-directional design 100, but these solvers quickly run into issues with performance and memory consumption. FastCAP, for instance, computes self and mutual capacitances of conductive three-dimensional (3D) structures embedded in a homogeneous or inhomogeneous dielectric. Input data, specifying (1) discretization of conductors and (2) discontinuity surfaces as triangular or quadrangular panels in a 3D space, are typically provided in a file to the field solver. Since a constant charge density is associated with every panel in the 3-D space, the panel's dimensions are a key factor to obtaining accurate outputs from the solver. Including smaller panels in the input data can lead to more accurate outputs by the EM solver, but at the cost of run-time and memory usage.

Further complicating issues for capacitance extraction tools is the fact that manufactured semiconductor interconnect structures are generally not exactly the same as the drawn interconnect wires on the design layout due to the non-idealities of manufacturing. In IC manufacturing, significant corner rounding, necking, and pinching takes place, leaving the manufactured interconnect curves significantly different from expectations associated with the design layout. One approach for improving manufacturability of interconnect wires is to avoid drawing the interconnect wires with square corners in the IC design, and to draw them in a curvilinear form instead. FIG. 2 illustrates a portion of an IC design 200 having omni-directionally routed interconnect wires 205 on a particular IC layer. The interconnect wires 205 in FIG. 2 are drawn in curvilinear form where corner rounding is evident at the line ends and junctions. Such an IC design 200 with curvilinear wires may be more manufacturable than a design with square-ended equivalent wires. Achieving accurate capacitance extraction for large designs that include these interconnect wires, however, remains a challenge for the industry.

### BRIEF SUMMARY

Some embodiments provide a layout verification tool that computes parasitic parameters for a design layout that defines a design for a region of an integrated circuit (IC). In some embodiments, the layout verification tool divides the design layout into tiles and interconnects in the design layout into interconnect segments, using a solver to compute parasitic values for the interconnect segments within groups of neighboring tiles, and using these parasitic values for the interconnect segments to compute the overall parasitic values for the full interconnects.

The interconnects of the design layout, in some embodiments, traverse one or more interconnect layers of the design and represent wires (and, in some cases, other conductors such as vias) that traverse one or more wiring layers of the IC. The IC design layout of some embodiments includes omni-directional interconnects within one or more layers; i.e., interconnects that are not parallel, perpendicular, or at 45° angles to each other. In addition, these interconnects may include curvilinear features (e.g., rounded corners, pinching, etc.) introduced either within the design layout itself or in a set of predicted manufactured shapes generated for the design layout. These features (multi-directionality and curvilinearity) make the calculation of parasitic parameters for the design layout especially difficult for existing pattern-matching tools. However, the invention is also applicable to Manhattan IC designs and/or interconnects with entirely rectilinear features.

In some embodiments, the parasitic parameters computed for the design layout are the self-capacitance of each interconnect and the capacitive coupling between each pair of neighboring interconnects. These are based on self-capacitance values computed for each interconnect segment and capacitive coupling values computed between each pair of interconnect segments in the same tile or in neighboring tiles in some embodiments.

The design layout is divided into a set of tiles in some embodiments based, e.g., on the concentration (density) of interconnects in the design layout region (e.g., with the lengths of the tile edges being a small multiple of the typical distance between interconnects). For a two-dimensional (2D) design layout that represents, e.g., a single layer of the IC, the tiles are 2D tiles (e.g., squares or other rectangles). For a three-dimensional (3D) design layout representing, e.g., multiple IC layers, the tiles are 3D cells (e.g., cubes or other rectangular prisms). For simplicity, the discussion herein primarily refers to 2D design regions and rectangular tiles, though the invention is equally applicable to 3D design regions as well as non-rectangular (e.g., hexagonal) tiles. In addition, in some embodiments, the layout verification tool defines a set of padding tiles around the edges of the design region, to ensure that each tile of the actual IC design region is fully surrounded by neighboring tiles.

In some embodiments, all of the tiles are equally sized within the design layout. In some cases, however, the interconnect density may vary from one region of the design layout to another. In some such embodiments, the layout verification tool divides different regions of the design layout into differently sized tiles based on these varying interconnect densities.

Based on the division of the design region into tiles, the interconnects are divided into interconnect segments. In some embodiments, each interconnect includes at least one interconnect segment, and at most one contiguous interconnect segment per tile (an interconnect may have two separate interconnect segments within a single tile if the interconnect leaves the tile, bends, and returns to the tile). At least a subset of the interconnects of the IC design region span multiple tiles and thus include multiple interconnects. In performing this division, in some embodiments the layout verification tool defines and stores (e.g., in memory) data structures mapping each interconnect to its set of one or more constituent interconnect segments.

The layout verification tool of some embodiments iterates over each tile of the IC design region and computes the self-capacitance and capacitive coupling values for the interconnect segments located in each tile. For a given tile (referred to as a “core” or “center” tile), some embodiments compute (i) the self-capacitance of each interconnect segment located in the tile, (ii) the capacitive coupling between each pair of interconnect segments located in the tile, and (iii) the capacitive coupling between each interconnect segment located in the tile and each interconnect segment located in each of the neighboring tiles (also referred to as “halo” tiles). Because these values typically need to be computed for many (e.g., thousands, millions) of individual tiles in order to verify the entire design layout, some embodiments use a graphics processing unit (GPU) or multiple GPUs to perform the same computations in parallel for each of numerous tiles.

To calculate at least the capacitive coupling values, some embodiments provide the sub-region including the current tile and its neighboring tiles to a field solver such as an electromagnetic (EM) field solver (also referred to as an EM solver) or another type of field solver. The field solver calculates electromagnetic parameters (e.g., self-capacitance or capacitive coupling) by directly solving Maxwell's equations for a set of conductors separated by dielectrics. Thus, for each sub-region, the layout verification tool provides the EM solver at least (i) the location and size (e.g., in three dimensions) of the interconnect segments and (ii) the nature of the dielectric material(s) (e.g., their relative permittivity values) separating these interconnect segments. In some embodiments, small gaps defined between interconnect segments of the same interconnect (i.e., at the tile boundaries) are given a relative permittivity of 1. The EM solver then returns the requested capacitance values. Because such EM solvers directly solve Maxwell's equations for any given arrangement of conductors and dielectrics, the EM solvers can compute the capacitance values for interconnects that are defined in any direction relative to each other, rather than being restricted to Manhattan or 45° wiring.

Other embodiments, rather than using an EM field solver, rasterize each sub-region as an arrangement of pixels (e.g., similar to an image) and provide the pixel arrangement to a machine-trained network (e.g., a convolutional neural network) that has been trained (e.g., using data generated from an EM field solver) to output capacitance values between conductor segments. The interconnect segments are represented by a first set of pixel values while different dielectrics are represented by other pixel values, and this arrangement of pixel values is propagated through the machine-trained network to output the various capacitance values for a sub-region (a center tile and its neighboring tiles).

Using this tiling technique, the capacitive coupling between each pair of interconnect segments in neighboring tiles will be calculated twice, when each of the interconnect segments in the pair is located in the center (core) tile. However, these two capacitive coupling values will often vary slightly because the field solver or machine-trained network is solving a slightly different problem each time (i.e., analyzing a slightly different set of conductors) due to the overall set of neighboring tiles (and thus overall set of interconnect segments) being different when the two different tiles are the center tile. As such, for each of these values, the layout verification tool of some embodiments computes a single capacitive coupling value based on the two values computed during the iterative computation process. For instance, some embodiments compute an average of these two values.

The capacitance values resulting from the iterative technique are (i) the self-capacitance for each interconnect segment and (ii) the capacitive coupling between each pair of interconnect segments that are either located in the same tile or in neighboring tiles. Some embodiments integrate these capacitance values to arrive at (i) the self-capacitance for each interconnect and (ii) the capacitive coupling between each pair of neighboring interconnects. Neighboring interconnects, in this case, include any pair of interconnects with interconnect segments located in the same tile or in neighboring tiles.

To calculate the total self-capacitance for a given interconnect, the layout verification tool of some embodiments adds together (i) the self-capacitance of each interconnect segment of the interconnect and (ii) the (averaged) capacitive coupling between neighboring interconnect segments of that interconnect. To calculate the total capacitive coupling between a specific pair of interconnects, the layout verification tool of some embodiments adds together (i) the capacitive coupling between pairs of interconnect segments belonging to those two interconnects that are located in the same tile and (ii) the (averaged) capacitive coupling between pairs of interconnect segments belonging to those two interconnects that are located in neighboring tiles. Different embodiments may perform this integration after all of the segment capacitance values have been computed (i.e., after all iterations of the center tile are complete for the IC design) or on an ongoing basis (i.e., adding any segment capacitance values to the appropriate interconnect self-capacitance or capacitive coupling total as those segment capacitance values become available).

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an IC design with omni-directional routes on multiple circuit layers.

FIG. 2 illustrates a portion of an IC design having omni-directionally routed interconnect wires on a particular IC layer.

FIG. 3 conceptually illustrates a process of some embodiments for computing parasitic parameters for the interconnects of a design layout that defines a design for an IC region.

FIG. 4 conceptually illustrates the application of a tiling grid to the IC design region shown in FIG. 2.

FIG. 5 illustrates a graph showing the capacitance between two adjacent wire structures as a function of the distance between the two adjacent wire structures.

FIG. 6 conceptually illustrates the interconnects of the semiconductor design region of FIG. 2 divided into interconnect segments by the tiling grid of FIG. 4.

FIG. 7 conceptually illustrates a more detailed view of a sub-section of the semi-conductor design region of FIG. 2 with the interconnects divided into interconnect segments.

FIG. 8 conceptually illustrates a selection of a tile within the sub-section of the semiconductor design region shown in FIG. 7.

FIG. 9 conceptually illustrates a process of some embodiments for computing the capacitance values for the interconnect segments of a selected tile.

FIG. 10 conceptually illustrates a selected tile having two interconnect segments as well as eight neighboring tiles with a total of eleven additional interconnect segments.

FIG. 11 conceptually illustrates the same section of an IC design region as FIG. 10 but a different selected tile.

FIG. 12 conceptually illustrates a plan view of a 3D problem that is extruded from the 2D region shown in FIG. 10.

FIG. 13 conceptually illustrates a plan view and an oblique view of a 3D problem to provide to an EM solver.

FIG. 14 conceptually illustrates an example of a curved edge of an interconnect segment that is converted into a pixel map through rasterization.

FIG. 15 conceptually illustrates a process of some embodiments for computing the combined capacitance values for the IC design region.

FIG. 16 conceptually illustrates a first set of tiles within a design layout region in which a first tile is the halo tile and a second set of tiles in which a second tile is the halo tile and the first tile is one of the neighboring tiles.

FIG. 17 illustrates example capacitive coupling values computed for the interconnects shown in FIG. 16, in two tables that correspond respectively to the two sets of tiles.

FIG. 18 conceptually illustrates a 3D tiling grid using differently sized tiles.

FIG. 19 conceptually illustrates a set of interconnect segments in a portion of a 3D region.

FIG. 20 conceptually illustrates a process of some embodiments for dynamically determining tile sizes within a region of a design layout.

FIG. 21 conceptually illustrates an example of an IC design layout region with a set of interconnects for a single layer.

FIG. 22 conceptually illustrates the tiling for four sub-regions of the IC design layout region shown in FIG. 21.

FIG. 23 conceptually illustrates a process of some embodiments for designing and manufacturing an IC.

FIG. 24 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a layout verification tool that computes parasitic parameters for a design layout that defines a design for a region of an integrated circuit (IC). In some embodiments, the layout verification tool divides the design layout into tiles and conductive circuit components in the design layout into component segments, using a solver to compute parasitic values for the component segments within groups of neighboring tiles, and using these parasitic values for the component segments to compute the overall parasitic values for the full interconnects.

In some embodiments, the design layout is a design layout for a wire structure that is to be manufactured on a substrate, such as a silicon wafer. In some such embodiments, the wire structure includes several interconnects (e.g., a type of conductive circuit components). These interconnects of the design layout, in some embodiments, traverse one or more interconnect layers of the design layout and represent wires that traverse one or more wiring layers of the IC. In some embodiments, the wires of the IC that are represented by the interconnects can encompass any kind of conductive material that electrically connects two nodes in the IC. These wires may be used to carry signals from one IC node to another IC node. In some embodiments, the interconnects represent both wires that traverse within one wiring layer of the IC and vias or other z-axis connections within the IC that traverse between wiring layers of the IC.

The IC design layout of some embodiments includes omni-directional interconnects within a layer; i.e., interconnects representing wires that are not parallel, perpendicular, or at 45° angles to each other. In addition, these interconnects may include curvilinear features (e.g., rounded corners, pinching, etc.). In different embodiments, the design layout itself may include interconnects with curvilinear features and/or the design layout includes only interconnects with rectilinear features but various algorithms are used to identify predicted manufactured shapes for these interconnects, which have curvilinear features. These features (multi-directionality and curvilinearity) make the calculation of parasitic parameters for the design layout especially difficult for existing pattern-matching tools. However, the invention is also applicable to Manhattan IC designs and/or interconnects with entirely rectilinear features.

In some embodiments, the parasitic parameters computed for the design layout are the self-capacitance of each interconnect and the capacitive coupling between each pair of neighboring interconnects. These are based on self-capacitance values computed for each interconnect segment and capacitive coupling values computed between each pair of interconnect segments in the same tile or in neighboring tiles in some embodiments. However, it should be understood that the while the description below primarily refers to the calculation of self-capacitance and capacitive coupling, the inventions described below can be used to compute other parasitics such as parasitic resistance and/or parasitic inductance for an individual interconnect as well as mutual inductance between a pair of interconnects.

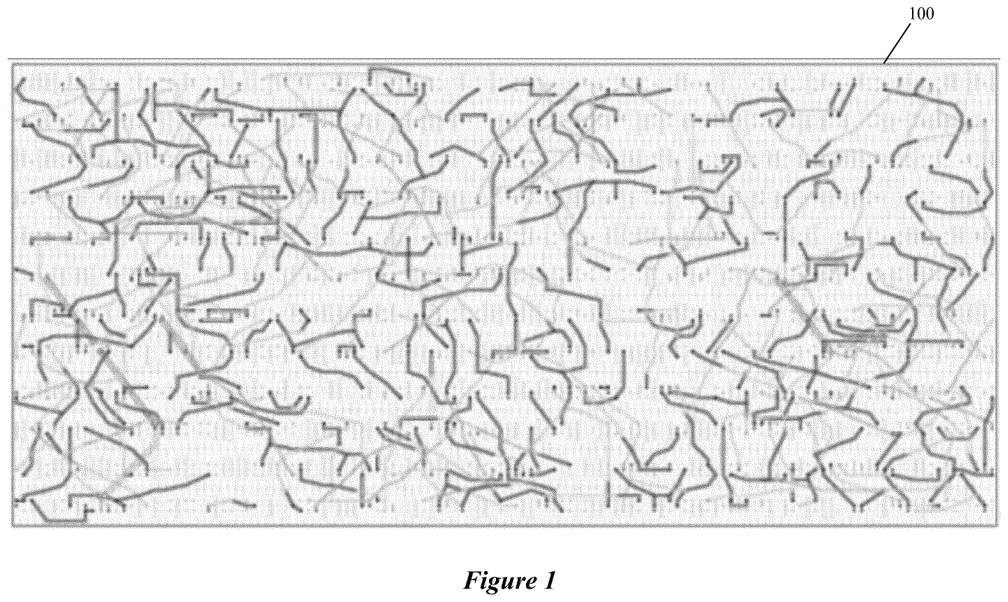

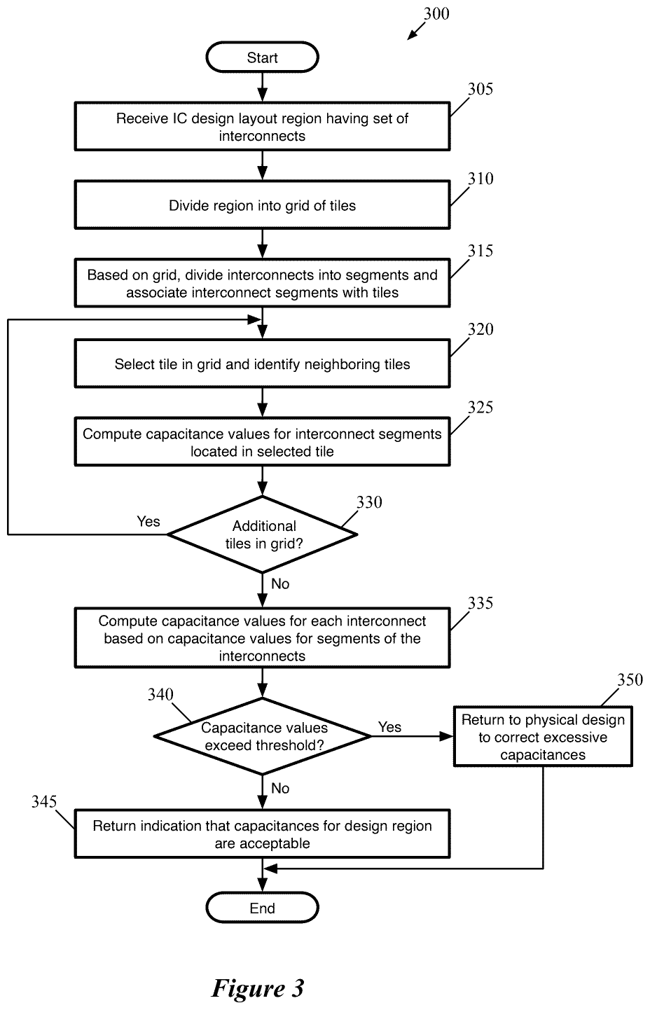

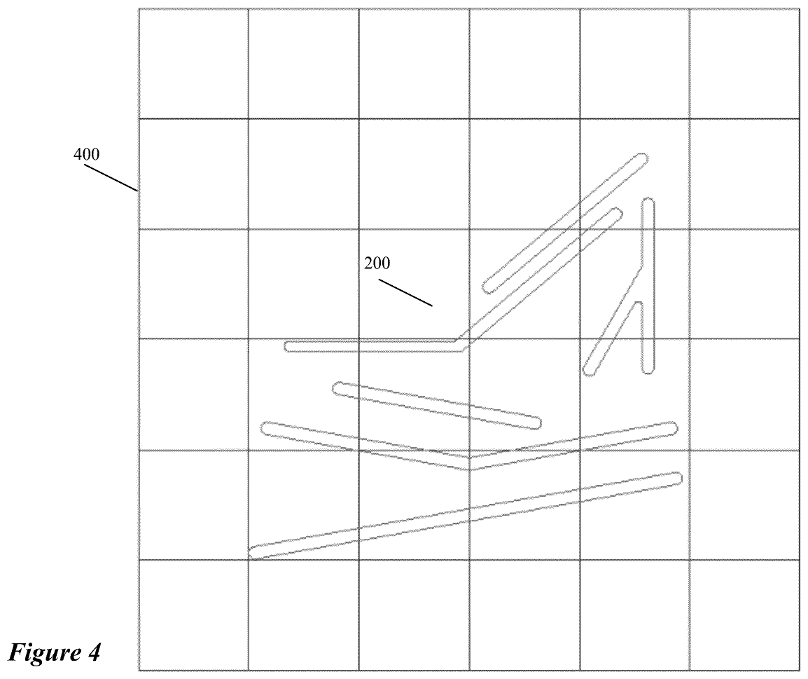

FIG. 3 conceptually illustrates a process 300 of some embodiments for computing parasitic parameters (specifically capacitance values) for the interconnects of a design layout that defines a design for an IC region (an IC design layout). The process 300, unlike previous methods for parasitic extraction, is applicable to large design layouts that may utilize any direction of interconnects. That is, while the process 300 can be applied to Manhattan and/or diagonal interconnects, this process can also be applied to IC designs that use omni-directional routing (e.g., as shown in FIG. 1) and to the shapes of actual predicted manufactured wafers with corner rounding and other non-straight-line aspects. The process 300 is performed, in some embodiments, by a layout verification tool that determines whether an IC design layout meets a set of requirements, including parasitic parameter thresholds. The process 300 will be described in part by reference to FIGS. 4-8, which conceptually illustrate the division of an IC design layout into tiles and the corresponding division of the interconnects within that region into interconnect segments.

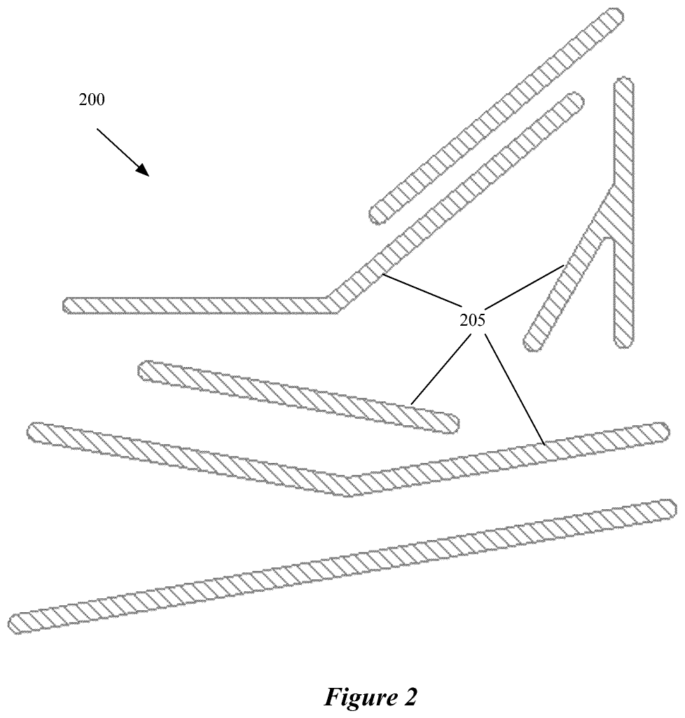

As shown, the process 300 begins by receiving (at 305) a region of an IC design layout having a set of interconnects. The IC design layout, in some embodiments, is the output of a set of physical design operations that are part of an overall electronic design automation (EDA) process. The semiconductor design region may be an entire IC design (e.g., as shown in FIG. 1) or a smaller portion of such an IC design (e.g., as shown in FIG. 2). The interconnects in the semiconductor design may include any direction of interconnects (e.g., various diagonal directions with neighboring interconnects that are not parallel, perpendicular, or at 45° angles), with or without corner rounding and other curvilinear aspects, and in one or multiple layers of interconnects.

The process 300 divides (at 310) the received IC design region into tiles. It should be noted that while this description relates to two-dimensional (2D) tiling of a semiconductor design region, the processes described herein are also applicable to three-dimensional (3D) tiling using rectangular prisms (e.g., cubes) as 3D tiles rather than rectangles (e.g., squares). The tiles are uniformly sized (e.g., squares) in some embodiments, while other embodiments use rectangular tiles of varying size (e.g., based on varying concentration of wire structures within different sections of the semiconductor design region).

FIG. 4 conceptually illustrates the application of a tiling grid 400 to the IC design region 200 shown in FIG. 2. In this example, the tiling grid 400 uses equally sized squares to divide the IC design region. In addition, as shown, some embodiments add a boundary of additional (blank) tiles to the region so that each tile that includes a portion of at least one interconnect can be in the center of a 3×3 grid of tiles (as described further below).

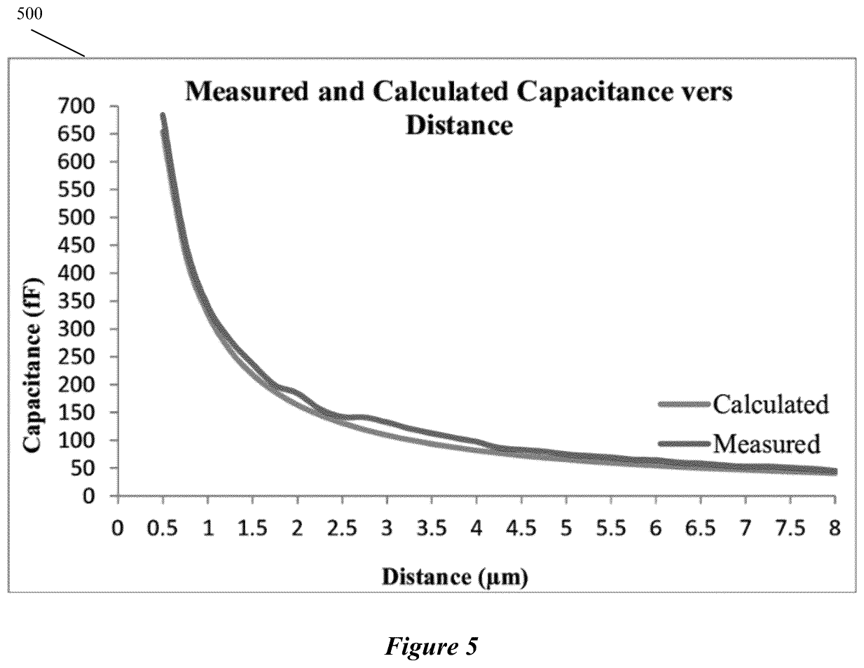

In some embodiments, the tile size for he tiling grid is selected based on the observation that the capacitance of adjacent wire structures in an IC (represented by the interconnects in the IC design) decreases inversely proportional to the distance between the wire structures. FIG. 5 illustrates a graph 500 showing the capacitance between two adjacent wire structures as a function of the distance between the two adjacent wire structures. The graph 500 shows how the calculated and measured capacitance of the two adjacent wire structures decreases as the distance between them increases. Specifically, as the distance between the two adjacent wire structures increases, the capacitance between the wire structures quickly falls to very small values. In applying the tiling grid 400, some embodiments attempt to keep neighboring interconnect segments that will have a large capacitive coupling within the same tile. For instance, some embodiments use a (small) multiple of the distance between the neighboring interconnects, though other embodiments may use different tile sizes.

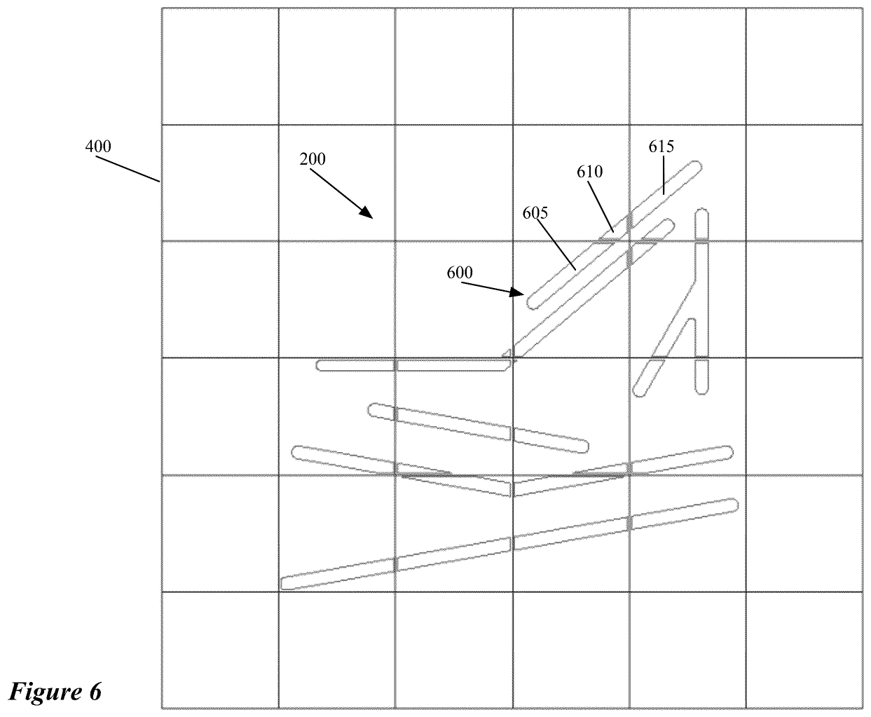

Next, based on the tiling grid, the process 300 divides (at 315) the interconnects into segments and associates the interconnect segments with the tiles. In some embodiments, each interconnect has at most one contiguous interconnect segment per tile. However, a particular interconnect may have multiple interconnect segments per tile if the particular interconnect leaves the tile, bends, and returns to the tile. FIG. 6 conceptually illustrates the interconnects of the semiconductor design region 200 divided into interconnect segments by the tiling grid 400. For example, the interconnect 600 is divided into three interconnect segments 605-615 by the tiling grid 400, with each of these interconnect segments 605-615 being associated with a different one of the grid tiles. While this figure illustrates visible gaps between the interconnect segments, it should be understood that in some embodiments these gaps are extremely small (i.e., would not be visible to the human eye even on the scale shown in these figures). For designs such as shown in this example in which the interconnects have curvilinear features and are omni-directionally routed, the interconnect segments will often have non-uniform shapes. Some of the interconnect segments will have two, three, or four straight edges (e.g., based on the interconnect shape and/or the tile edges), while other interconnect segments may have fewer such straight edges.

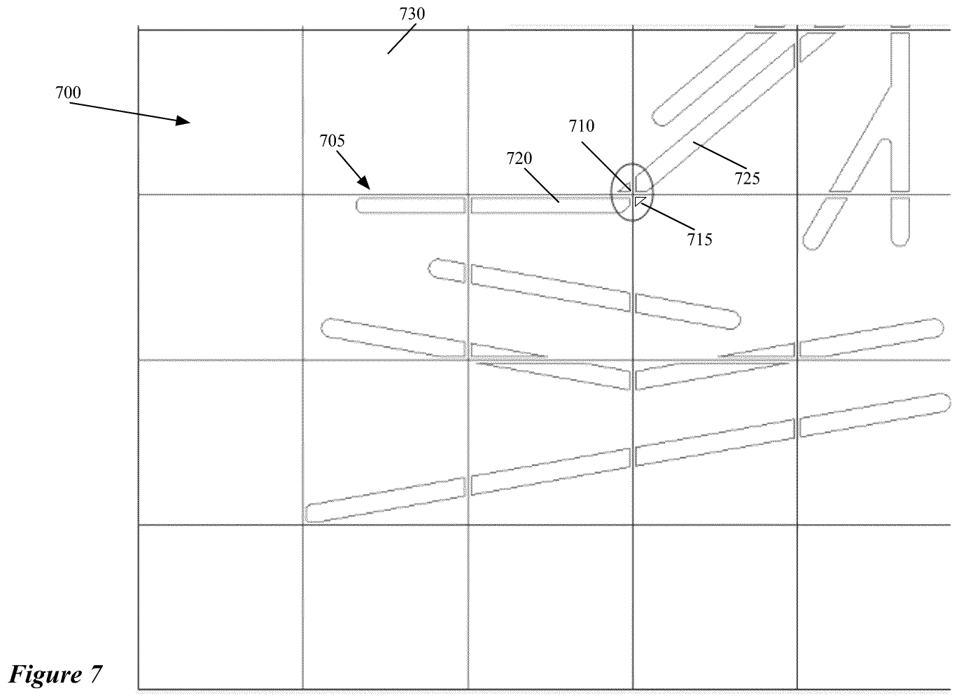

In some embodiments, certain interconnect segments may be significantly smaller than others. In fact, some embodiments remove interconnect segments that fall below a threshold size from the analysis, as the amount of capacitive coupling caused by such segments is minimal. FIG. 7 conceptually illustrates a more detailed view of a sub-section 700 of the semi-conductor design region 200 with the interconnects divided into interconnect segments. As shown, two of the interconnect segments 710 and 715 of the interconnect 715 are very small relative to the other interconnect segments (e.g., interconnect segments 720 and 725). Some embodiments discard these small interconnect segments 710 and 715 from the capacitance calculations, as the smallest segments (those below a threshold) can cause problems for a capacitance solver and do not have a significant effect on the overall capacitive coupling between the interconnects.

In addition to removing very small interconnect segments from analysis, some embodiments also allow users to selectively remove interconnects from the capacitance analysis. For instance, a user (e.g., an IC designer) might be able to visually determine that for certain interconnects the capacitance values will be small enough to not affect performance of the IC design. In this case, the user can skip having the verification tool perform capacitance extraction for these interconnects (i.e., all of the interconnect segments of the interconnect). Removal of interconnects from the capacitance analysis can (1) reduce the time needed for the solver to determine capacitances for a selected tile and (2) in certain cases reduce the number of tiles that include relevant interconnect segments (thereby reducing the number of separate problems provided to the solver).

To keep track of the interconnect segments, some embodiments define a set of data structures that (1) map interconnect segments to their original interconnects and (2) map interconnect segments to the tiles in which they are located. For instance, some embodiments define an array for each interconnect with the elements of the array being references to the different interconnect segments belonging to that interconnect. Similarly, some embodiments define an array for each tile with the elements of the array being references to the different interconnect segments located in that tile. These data structures can be used to remove certain interconnects from consideration as well. Other embodiments simply define capacitance matrices between the interconnect segments (1) for each tile and (2) for each pair of neighboring tiles, as described further below.

With the grid and interconnects defined, the process 300 can calculate the capacitive coupling between interconnect segments. Specifically, some embodiments compute, for each interconnect segment, (1) the self-capacitance for the interconnect segment and (2) the capacitive coupling between that interconnect segment and each interconnect segment that is in the same tile or in a neighboring tile (e.g., one of the eight neighboring tiles for each tile with an interconnect segment).

As shown, the process 300 selects (at 320) a tile in the grid and identifies the neighboring tiles for that tile. In some embodiments, the process sweeps over the entire tiling grid in order (e.g., top-left to bottom-right, bottom-left to top-right, etc.). In addition, it should be understood that the process 300 is a conceptual process and that the actual operations performed by the layout verification tool may differ slightly from the process shown in FIG. 3. For instance, while the process 300 shows a set of serial operations, in which one tile is selected at a time, it should be understood that other embodiments perform operations for multiple tiles in parallel. For instance, some embodiments use a graphics processing unit (GPU) or set of GPUs that can perform the same operation in parallel for many different data sets (e.g., for the interconnect segments of different selected tiles and their respective neighboring tiles).

Some embodiments only select tiles with at least one associated interconnect segment, excluding the padding tiles as well as any tiles within the semiconductor design region that do not include any interconnect segments. For instance, in FIG. 7, the padding tiles around the left and bottom edges of the design region would be excluded in addition to the tile 730, as no interconnect segments are located within any of these tiles.

In some embodiments, the neighboring tiles are those tiles located within one tile of the selected tile in any of the cardinal directions (up, down, left, right) or diagonal directions. That is, each tile (that is not one of the padding tiles) has eight neighboring tiles in such embodiments. The addition of the padding tiles around the edge of the semiconductor design region ensures that the border tiles of the design region also have eight neighboring tiles. Other embodiments use other sets of neighboring tiles for a given selected tile (e.g., only the four tiles directly above, below, and either side of the selected tile, the eight tiles located within one tile of the selected tile as well as the sixteen tiles located within two tiles of the selected tile, etc.).

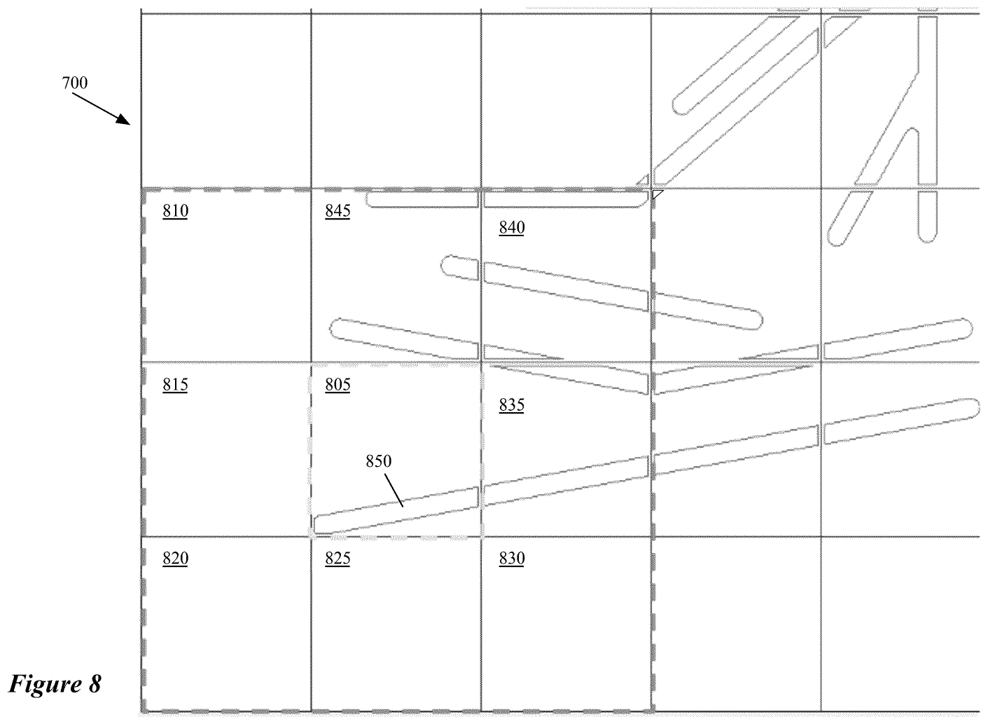

FIG. 8 conceptually illustrates a selection of a tile 805 within the sub-section 700 of the semiconductor design region. This tile 805 has eight neighboring tiles 810-845, five of which (tiles 810-830) are padding tiles without any interconnect segments. The selected tile 805 includes a single interconnect segment 850, while the other three neighboring tiles 835-845 each include two to three interconnect segments.

The process 300 then computes (at 325) capacitance values for the interconnect segments located within the selected tile. In some embodiments, these capacitance values include (1) self-capacitance values for each interconnect segment located in the selected tile, (2) capacitive coupling values between each pair of interconnect segments located in the selected tile, and (3) capacitive coupling values between each interconnect segment located in the selected tile and each interconnect segment located in one of the neighboring tiles. As described further below, some embodiments provide the set of interconnect segments within the selected tile and its neighboring tiles to a capacitance solver (also referred to as a field solver or EM solver), which computes the self-capacitance and/or capacitive coupling values and provides these values to the verification tool. In other embodiments, the interconnect segment information is provided to a machine-trained network that outputs the self-capacitance and/or capacitive coupling values and provides these values to the verification tool. Further description regarding both of these methods will be described further below.

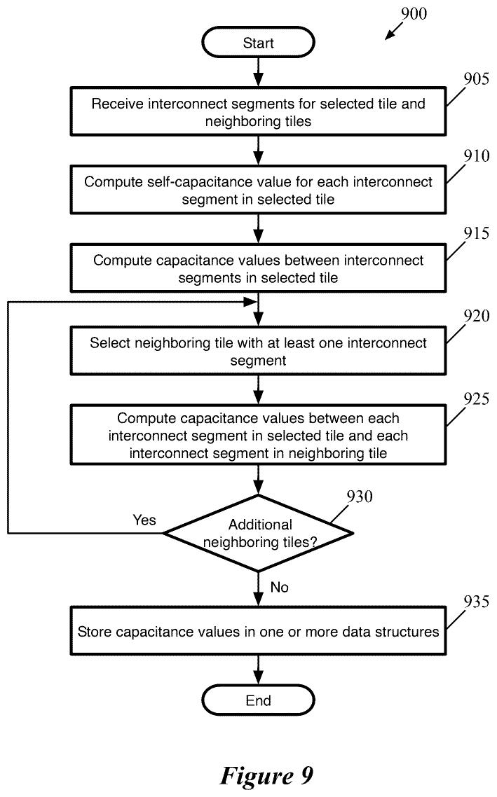

In the case of FIG. 8, the process would compute the self-capacitance of interconnect segment 850, the only interconnect segment located in the selected tile 805. As only this one interconnect segment 850 is present within the selected tile, there is no need to compute any capacitive coupling between interconnect segments within the selected tile 805. In addition, for each one of the neighboring tiles 835-845, the process computes (e.g., using an EM solver) the capacitive coupling value between the interconnect segment 850 and each of the interconnect segments located in that neighboring tile. Thus, in addition to the one self-capacitance value, eight capacitive coupling values are computed (for each of the eight interconnect segments located in the neighboring tiles 835-845). The computation of these various capacitance values will be described in further detail below by reference to FIG. 9.

Returning to FIG. 3, after computing the capacitance values for the selected tile, the process 300 determines (at 330) whether additional tiles in the grid remain for selection. If additional tiles remain, the process 300 returns to 320 to select another tile. As noted above, in some embodiments the process performs the operations 320 and 325 for multiple tiles in parallel, while in other embodiments each tile is selected serially.

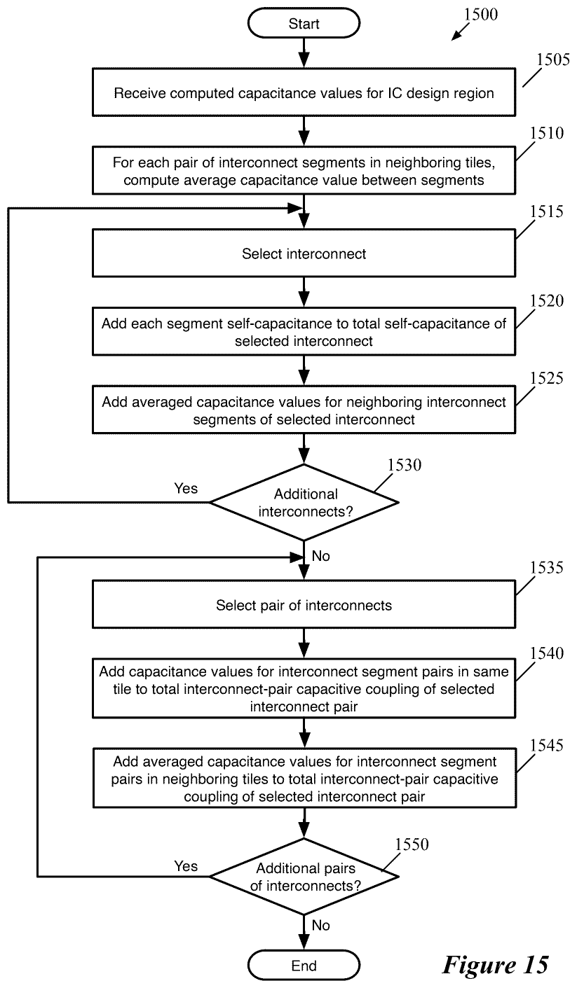

Once all of the tiles (or at least all of the tiles including at least one interconnect segment) have been selected and the capacitance values computed for all of the interconnect segments, the process 300 computes (at 335) capacitance values for each interconnect based on the capacitance values for the segments of the interconnect. In some embodiments, the layout verification tool uses the computed capacitance values for the interconnect segments as well as the interconnect-to-interconnect segment mapping data structures to determine (1) the total self-capacitance value for each interconnect and (2) the total capacitive coupling between each pair of interconnects that have at least one pair of respective interconnect segments located in the same or neighboring tiles. Some embodiments differentiate the treatment of interconnect segment pairs located in the same tile with the treatment of interconnect segment pairs located in neighboring tiles, as two separate capacitive coupling values will have been calculated between the interconnect segment pairs located in neighboring tiles. The techniques of some embodiments for computing the total capacitance values for the interconnects will be described in further detail below by reference to FIG. 15.

Once all of the capacitance values have been calculated for each of the interconnects, the process 300 determines (at 340) whether any of the capacitance values (e.g., the self-capacitances of individual interconnects or the capacitive coupling values between pairs of interconnects) exceed threshold values for the semiconductor design region. In some embodiments, this operation is part of the layout verification tool's parasitics checks to determine whether the semiconductor design is valid or needs to be modified.

If the capacitance values are all below the thresholds, then the process 300 returns (at 345) an indication that the capacitances for the design region are acceptable. In some embodiments, the layout verification tool provides feedback to a user (e.g., visual feedback via a display screen, audio feedback, etc.) to indicate which verification checks the semiconductor design has passed or failed.

On the other hand, if any (or at least a threshold number or percentage) of the capacitance values exceed their threshold, the process 300 returns (at 350) to the physical design process to correct the excessive capacitance values. In different embodiments, this may entail returning to the placement and/or routing processes within the overall physical design process. In some embodiments, the layout verification tool displays or otherwise provides a notification to a user to indicate (1) that the capacitance values have exceeded the threshold and/or (2) the specific interconnects that are the cause of the problem. In some embodiments, the layout verification tool is part of a suite of EDA tools and notifies one of the other physical design tools (e.g., a routing tool) of the specific parasitic capacitance issues identified via the parasitic extraction operations. This enables either automated modification to the semiconductor design layout, manual adjustment to the semiconductor design layout, or a combination thereof (e.g., changes to the routing of the interconnects in one or more layers of the design). In either case (i.e., whether or not the semiconductor design region passes the parasitic capacitance thresholds), the process 300 ends (though the process 300 may be repeated after modifications are made to the design layout in an attempt to correct the identified parasitic capacitance issues).

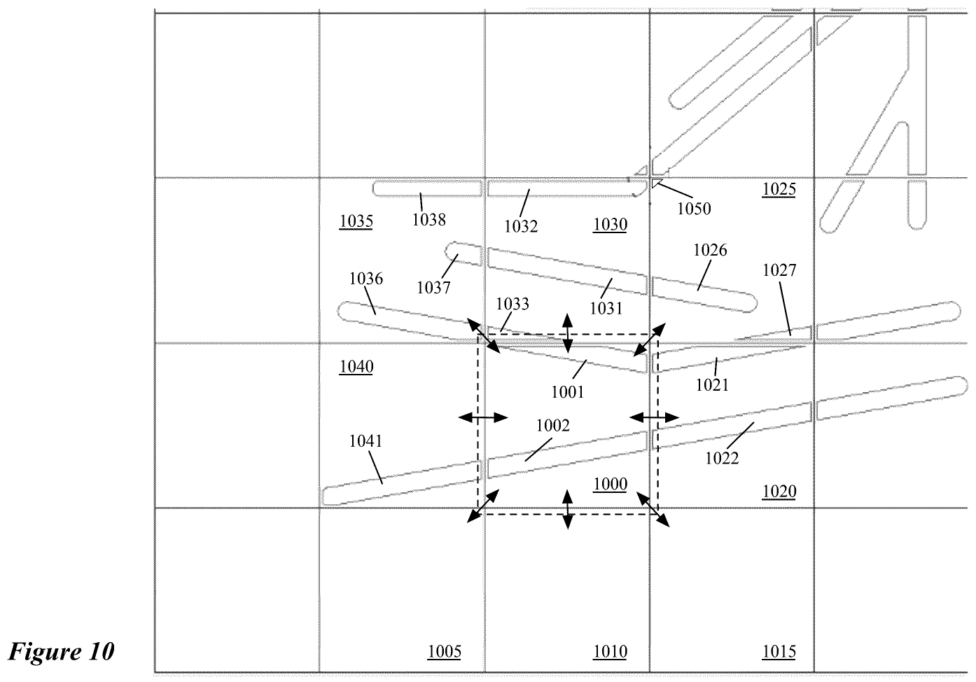

FIG. 9 conceptually illustrates a process 900 of some embodiments for computing the capacitance values for the interconnect segments of a selected tile (also referred to as a center tile or a core tile). As described above, in some embodiments the layout verification tool divides an IC region into a grid of tiles and iterates across the entire grid of tiles (selecting each tile as the core tile for one iteration), thereby computing capacitance values for the interconnect segments located in each tile. The process 900 is the process performed by some such embodiments at each iteration to compute these capacitance values for one of the tiles. The process 900 will be described by reference to FIGS. 10-13, which conceptually illustrate multiple different selected tiles as well as the data that is provided to a field solver in some embodiments to perform capacitance calculations.

As shown, the process 900 begins by receiving (at 905) the interconnect segments for a selected tile and for the neighboring tiles (also referred to as halo tiles) of that selected tile. As discussed above, for 2D computations (e.g., within a single layer), each selected tile has eight neighboring tiles in some embodiments, while for 3D computations each selected tile has 26 neighboring tiles in some embodiments. In some embodiments, if all of the tiles in the grid are the same size, the selected (core) tile and the neighboring (halo) tiles will be of equal size.

FIG. 10 conceptually illustrates a selected tile 1000 having two interconnect segments 1001 and 1002 as well as eight neighboring tiles 1005-1040 with a total of eleven additional interconnect segments. The three padding tiles 1005-1015 do not include any interconnect segments, while each of the tiles 1020 and 1025 have two interconnect segments 1021, 1022, 1026, and 1027, each of the tiles 1030 and 1035 have three interconnect segments 1031-1033 and 1036-1038, and the tile 1040 has a single interconnect segment 1041. The neighboring tile 1025 includes an additional interconnect segment 1050 that is removed from consideration on account of being below a size threshold and thus (1) having only a de minimis effect on the overall capacitance and (2) being unwieldy for the field solver to handle. A dashed line in the figure indicates the selected tile 1000 while arrows represent the relationship of the selected tile 1000 to the eight neighboring tiles 1005-1040.

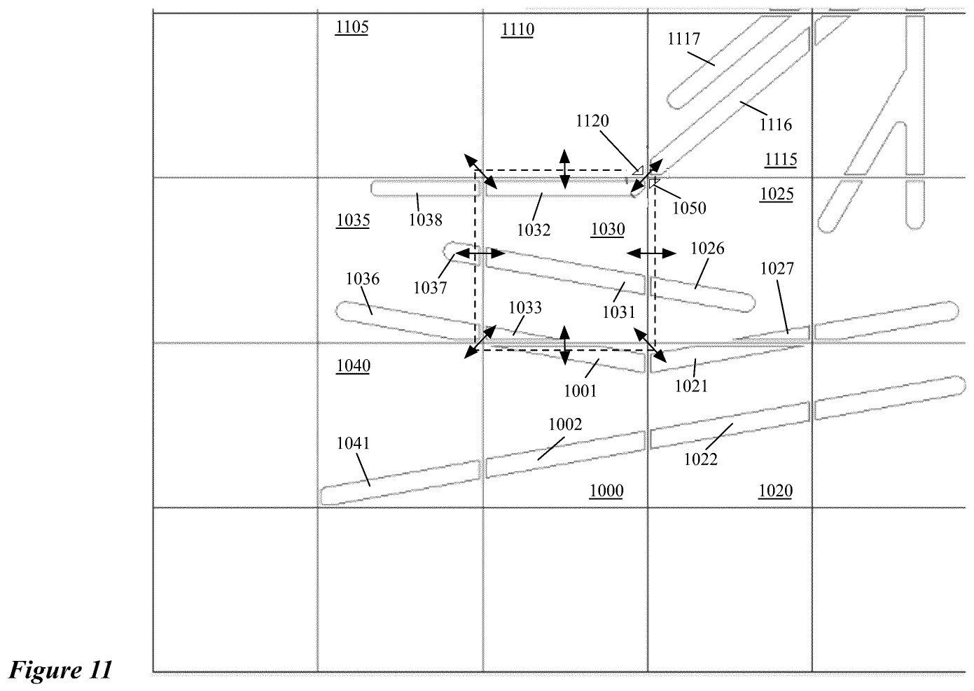

FIG. 11 conceptually illustrates the same section of an IC design region as FIG. 10, but with the tile 1030 as the selected tile. In this case, the selected tile 1030 includes three interconnect segments 1031-1033 while the eight neighboring tiles 1000, 1020-1040, and 1105-1115 include twelve additional interconnect segments. No padding tiles are included in the neighboring tiles of 1030, though tiles 1105 and 1110 do not have any interconnect segments. Each of the tiles 1000, 1020, 1025, and 1115 includes two interconnect segments 1001, 1002, 1021, 1022, 1026, 1027, 1116, and 1117. The neighboring tile 1035 includes three interconnect segments 1036-1038 while the tile 1040 includes a single interconnect segment 1041. Like the small interconnect segment 1050 in the tile 1025, the interconnect segment 1120 in tile 1110 is also discarded on account of being below the size threshold in some embodiments.

The process 900 computes, for the selected tile, all of the capacitance values relating to the interconnect segments of the selected tile. It should be noted that, in some embodiments, the computation for a selected tile provides the entire capacitance matrix for all interconnect segments in the selected tile and neighboring tiles (e.g., a 13×13 capacitance matrix for the thirteen interconnect segments shown in FIG. 10). In other embodiments, as described herein, the computation for a selected tile generates a set of smaller capacitance matrices, providing all of the capacitance values (self-capacitance values and capacitive coupling values) for each interconnect segment located in the selected tile. It should be understood that the various computations described in the process 900 need not be performed in the specific order shown in the figure. In addition, for a given tile, some embodiments perform at least a subset of the computations in parallel.

As shown, the process 900 computes (at 910) the self-capacitance value for each interconnect segment in the selected tile. Some embodiments directly solve the self-capacitance values without the need to hand off the computation to a field solver or machine-trained network. The self-capacitance of an interconnect segment, in some embodiments, is the amount of electric charge that would need to be added to the interconnect to raise its electric potential by one unit of measurement (e.g., one volt). In some embodiments, this can be computed using a standard formula for any given interconnect segment in isolation. In other embodiments, rather than directly computing the self-capacitance, the process determines the self-capacitance of an interconnect segment after computing all of the capacitive coupling values for the interconnect segment, by adding the absolute value of the capacitive coupling values for the interconnect segment.

The process 900 also computes (at 915) the capacitance values (e.g., capacitive coupling or mutual capacitance values) between the interconnect segments within the selected tile. In some embodiments, the process generates one capacitance value for each pair of interconnect segments within the selected tile. For instance, in FIG. 10, one capacitance value is generated for the capacitive coupling between interconnect segment 1001 and interconnect segment 1002. Because these interconnect segments are neither parallel nor perpendicular, but rather run at random diagonal directions relative to each other, a simple pattern matching tool cannot easily identify the capacitance values. Instead, some embodiments provide data regarding the interconnect segments to a capacitance calculation tool that performs the calculations. This capacitance calculation tool may be an electromagnetic (EM) field solver (e.g., FastCap or FastCap2) or a machine-trained network (e.g., a neural network) trained to generate outputs similar to an EM field solver.

The process 900 also computes capacitance values between the interconnect segments located in the selected tile and the interconnect segments in each of the neighboring tiles. As shown, the process 900 selects (at 920) one of the neighboring tiles with at least one interconnect segment. Any neighboring tiles without any interconnect segments can be skipped over for these purposes as no capacitive coupling values need to be computed for those neighboring tiles.

The process 900 then computes (at 925) the capacitance values (e.g., capacitive coupling or mutual capacitance values) between each interconnect segment in the selected tile and each interconnect segment in the current neighboring tile. Referring again to FIG. 10, for the selected tile 1000 and neighboring tile 1020, four capacitance values are computed: between interconnect segments 1001 and 1021, interconnect segments 1001 and 1022, interconnect segments 1002 and 1021, and interconnect segments 1002 and 1022. Similarly, for the selected tile 1000 and neighboring tile 1030 (with three interconnect segments 1031-1033), six capacitance values are computed.

As noted, in some embodiments the layout verification tool hands off the computation of the capacitance values to a field solver such as an electromagnetic (EM) field solver (also referred to as a capacitance solver). These EM solvers calculate electromagnetic parameters (e.g., self-capacitance or mutual capacitance) by directly solving Maxwell's equations for a set of conductors separated by dielectrics. Thus, for each sub-problem, the layout verification tool provides the EM solver at least (1) the location and size (e.g., in three dimensions) of the interconnect segments and (2) the nature of the dielectric material(s) (e.g., their relative permittivity values) separating these interconnect segments. Other field solver can determine the capacitances using other equations (e.g., Laplace equations and/or Poisson equations).

Other embodiments, rather than field solvers, use approaches that estimate capacitances via other mathematical techniques such as numerical integration (e.g., floating random walk approaches). Such “solvers” do not technically solve equations but rather use detailed approximation techniques to estimate the solutions (in this case the capacitance values).

For the capacitance values between interconnect segments within a selected tile, some embodiments only provide the solver with information about the segments located within the selected tile. Other embodiments, however, provide the solver with information about the larger region including all of the neighboring tiles. Similarly, for the capacitance values between interconnect segments within a selected tile and a particular neighbor tile, different embodiments may provide the solver with either (1) information about only the interconnect segments in the two tiles or (2) information about the entire region with all of the neighboring tiles. Some embodiments provide the latter information (for both the intra-tile capacitance values and inter-tile capacitance values) as the other interconnect segments in the region can affect the capacitive coupling between two interconnect segments. In addition, rather than separately providing the information to the EM solver for operation 915 and each iteration over operation 925, some embodiments provide this information once to the EM solver, which returns all of the requested capacitance values at one time (i.e., operations 910-930 or operations 915-930 are all performed as one problem handed off to the EM solver).

In some embodiments, the layout verification tool (or a separate intermediate tool) generates the information to provide to the EM solver. This process can involve extruding the 2D layout into a 3D structure, annotating the structure with relative permittivity values for the gaps between interconnect segments, and augmenting the structure with ground planes above and/or below. In some embodiments, the relative permittivity values and the ground planes are imported from a manufacturing process-specific data file (i.e., these values are dependent on the specifics of the manufacturing process). In addition, in some embodiments there is a very small gap between the interconnect segments of the same interconnect. Some embodiments use a dielectric constant with a relative permittivity of 1.0 (rather than the larger relative permittivity of the other gaps) for these small gaps to reduce any error that would be introduced by treating the interconnect segments as separate conductors.

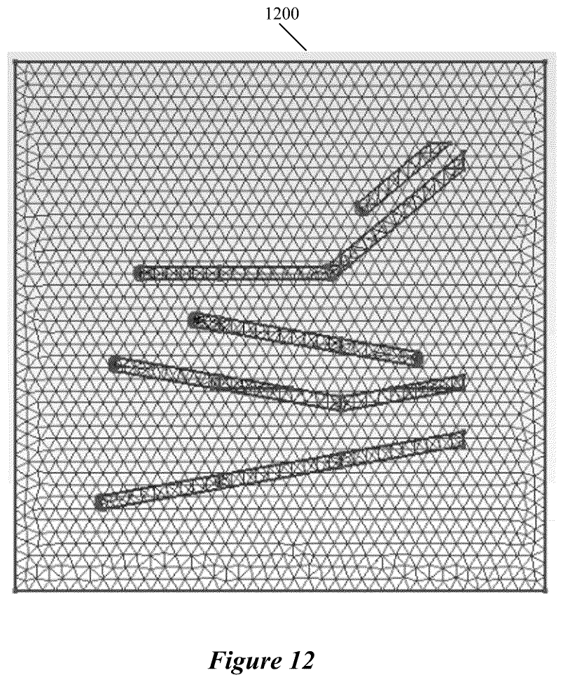

FIG. 12 conceptually illustrates a plan view 1200 of a 3D problem that is extruded from the 2D region shown in FIG. 10 (i.e., selected tile 1030 with neighboring tiles 1000, 1020-1040, and 1105-1115). In this plan view 1200, each interconnect segment is identified as a separate conductor while relative permittivity values for the intervening spaces are also specified (including the very small gaps between interconnect segments).

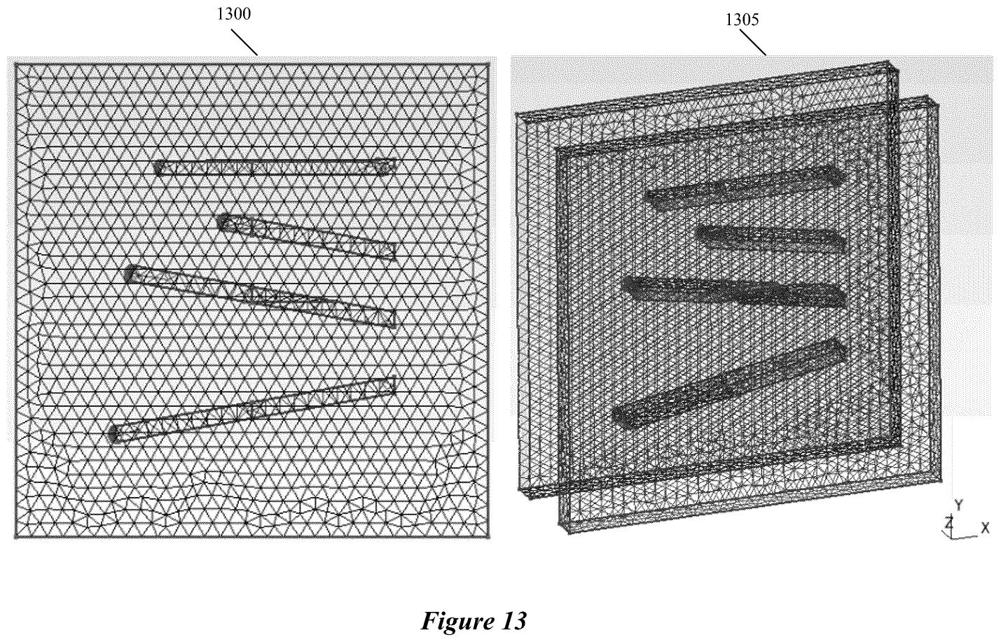

FIG. 13 conceptually illustrates a plan view 1300 and an oblique view 1305 of another 3D problem to provide to an EM solver. The oblique view illustrates that each conductor has both a thickness (in the x-y plane) and a height in the z dimension (in addition to the more apparent length of the segment). This view also illustrates the ground planes provided to the EM solver as part of the problem to be solved. In some embodiments, the EM solver returns a capacitance matrix indicating capacitive coupling values between each pair of interconnect segments (or at least each requested pair of interconnect segments).

Rather than using an EM solver, some embodiments use a pixel-based technique to compute the capacitive coupling values for the interconnect segments in a selected tile. For example, in some embodiments, the pixel-based technique may be implemented using a machine-trained network (MTN), such as a convolutional neural network. Examples of using machine-trained networks to compute capacitance values are described in detail in U.S. Patent Publication 2023/0027655, which is incorporated herein by reference.

Such an MTN, in some embodiments, receives as input a pixel-based representation of a set of interconnect segments (e.g., a 2-D pixel-based representation) and outputs a set of capacitance values for the interconnect segments. In some embodiments, the input also includes relative permittivity values for non-interconnect pixels and/or a delineation of the different interconnect segments (i.e., specifying interconnect pixels as belonging to specific interconnect segments).

To train such an MTN, some embodiments generate numerous pixel representations of arrangements of interconnect segments as well as ground-truth capacitance values for the interconnect segments in these arrangements, then perform network training. Some embodiments use an EM field solver (e.g., with geometric-based input) to generate the ground-truth capacitance values for each interconnect segment arrangement. The network training system of some embodiments forward propagates batches of these training inputs through the network to generate outputs, compares the generated outputs (capacitance values) with the ground-truth outputs (e.g., generated by an EM field solver), then modifies network parameters (e.g., weight and bias values) based on these comparisons (e.g., by using a loss function and backpropagating that loss function to determine the parameter adjustments).

Some such embodiments incorporate a pixel-based technique so that GPU or TPU hardware can be used to accelerate operations for determining the capacitances for the different sub-regions (e.g., groups of nine tiles) in parallel. The pixel-based technique involves rasterizing each sub-problem into a pixel image (a set of pixel values) indicating which of the pixels of the pixel image belong to a pair of interconnects or interconnect segments whose coupling capacitance is to be determined. In some embodiments, this image rasterization produces white pixels for pixels that are fully within an interconnect segment, black pixels for pixels that are fully outside of any interconnect segments, and grey pixels for pixels that are partially covered by an interconnect segment. In some such embodiments, the pixels fully covered by interconnect segments are represented with the numerical value 1.0, the pixels fully outside of the interconnect segments are represented with the value 0.0, and partially covered pixels are represented with a value in the range [0,1] representative of the area of the pixel which is filled by the interconnect segment (e.g., a pixel that is 50% filled will have a value of 0.5).

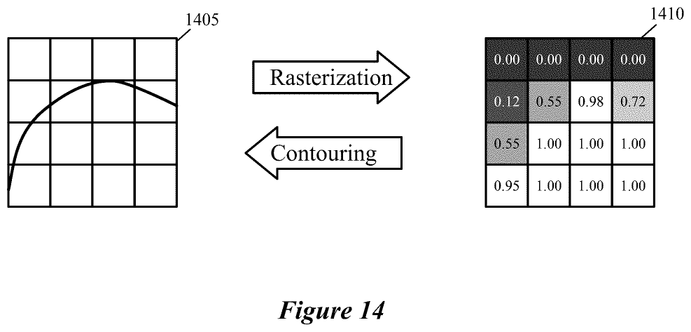

A rasterized layout image is also referred to as a pixel map, and the numerical values referred to as pixel values. FIG. 14 conceptually illustrates an example of a curved edge of an interconnect segment 1405 that is converted into a pixel map 1410 through rasterization. This is an example of a raster tone map (RTM), in which the pixel data that is created by rasterization has three kinds of pixels: exterior pixels with a pixel value 0, interior pixels with a pixel value 1 and edge pixels with pixel values greater than 0 and smaller than 1.

In some embodiments, edge pixels correspond to the areas where the original geometry data had an edge, and the pixel value of any one pixel corresponds to the area of the pixel covered by that geometry data. The accuracy of rasterization depends on the pixel size used for sampling the geometries such that the pixel value indicates the normalized area of the geometry data overlapping the corresponding pixel area. As indicated in FIG. 14, contouring is the opposite process to rasterization. Contouring reconstructs the geometry data from the pixel data.

Instead of RTMs, other embodiments use continuous tone maps (CTMs) or quantized tone maps (QTMs). In such tone maps, the pixel values are in a range that starts below a threshold value and ends above a threshold value. In CTM or QTM, the data typically varies more gradually from pixel to pixel than the rasterized data. Also, in some embodiments of CTM or QTM, the pixels with values below the threshold value are exterior pixels, the pixels with values above the threshold value are interior pixels, and the pixels with values at or near the threshold values are edge pixels. CTM and QTM values are often used when the source of pixel data is computational lithography. QTM values are quantized two-dimensional values of a continuous function and the pixel values do not directly encode the area coverage.

Since both rasterization and contouring operations are computationally intensive, some embodiments stay in the pixel-based computing domain for purposes of efficiency. For instance, parasitics extraction is performed completely in the pixel domain in some embodiments in order to eliminate the need for conversion to and from the contour domain. In addition, performing successive computations in the pixel domain enables data to be transferred to GPUs, which tend to be more efficient for pixel-based computations, and then stay on the GPU as the data is transformed (i.e., rather than repeatedly transferring data between a CPU and one or more GPUs).

In some embodiments, the pixel images are then used as input to the MTN, the outputs of which are capacitance values for pairs of interconnects or interconnect segments. The pixel-based technique then recomputes the images for each pair of interconnects or interconnect segments of interest and computes the capacitance values for each pair of interconnects or interconnect segments of interest using the MTN.

Returning to FIG. 9, the process 900 determines (at 930) whether additional neighboring tiles remain for the selected tile. It should be understood that the process 900 is a conceptual process and that, as noted above, in some embodiments all of the capacitance values relating to the interconnect segments located in the selected tile are computed at once. That is, rather than iterating over operations 920 and 925 for each neighboring tile, a single problem is provided to the EM solver and the capacitances between each interconnect segment in the selected tile and each other interconnect segment in the region are computed. Similarly, some embodiments rasterize the entire region and provide the region as input to an MTN, which outputs all of the capacitances between each interconnect segment in the selected tile and each other interconnect segment in the region. Other embodiments, as noted, compute the capacitance values one neighboring tile at a time.

Once all of the capacitance values have been computed, the process 900 stores (at 935) these capacitance values in one or more data structures. Again, as noted, the process 900 is a conceptual process. Some embodiments actually store the capacitance values in the one or more data structures as each value or set of values is computed (e.g., returned from the solver or machine-trained network). These data structures, in some embodiments, are capacitance matrices (e.g., either a single capacitance matrix for the entire region of nine tiles or a separate capacitance matrix for the selected tile and each pair of selected tile and neighboring tile).

As indicated above, after all of the capacitance values are computed for the interconnect segments in each region (e.g., for each region of nine tiles), the layout verification tool combines the capacitance values for each interconnect based on the values computed for each interconnect segment that is a part of the interconnect. FIG. 15 conceptually illustrates a process 1500 of some embodiments for computing the combined capacitance values for the IC design region. In some embodiments, the process 1500 is performed by a layout verification tool at operation 335 of the process 300 shown in FIG. 3.

As shown, the process 1500 begins by receiving (at 1505) the computed capacitance values for an IC design region. These capacitance values, in some embodiments, are the values computed by the process 900 (or a similar process). As described, in some embodiments at least a subset of the capacitance values are computed by an EM field solver, a machine-trained network, or another tool. In some embodiments, the capacitance values are stored in a set of capacitance matrices for each region of interconnect segments (e.g., for a 2D IC design region, each 9-tile region).

The process 1500 then computes (at 1510), for each pair of interconnect segments located in neighboring tiles, the average capacitance value between the interconnect segments. Using the process 900 shown in FIG. 9, the capacitive coupling between each pair of interconnect segments located in neighboring tiles will be calculated twice, once when each of the tiles is the selected tile at the center of the region analyzed by, e.g., the EM field solver. For instance, referring to FIG. 10, the coupling capacitance between interconnect segment 1002 in the tile 1000 and interconnect segment 1031 in the tile 1030 is computed and stored when the tile 1000 is the selected tile. When the tile 1030 is the selected tile, as in FIG. 11, this same coupling capacitance is also computed and stored.

However, the two coupling capacitance values may be slightly different, owing to the difference in the other interconnect segments that the EM field solver (or other tool) accounts for when computing these capacitance values. In FIG. 10, the problem provided to the field solver includes the interconnect segments located in tiles 1000-1040, whereas in FIG. 11, the problem provided to the field solver includes the different interconnect segments located in tiles 1000, 1020-1040, and 1105-1115. Because the EM field solver bases its calculations on solving Maxwell's equations for the specific configuration of conductors and dielectrics provided, the capacitive coupling between interconnect segments 1002 and 1031 may be slightly different. To reconcile this, some embodiments compute the average (i.e., the mean) of the two capacitive coupling values for each such interconnect segment pair. This includes both interconnect segment pairs from two different interconnects as well as interconnect segment pairs belonging to the same interconnect. On the other hand, (1) interconnect segment pairs located in the same tile and (2) self-capacitance values computed for interconnect segments do not need averaging, as these values are only computed once (when those interconnect segments are located in the selected center tile for a region).

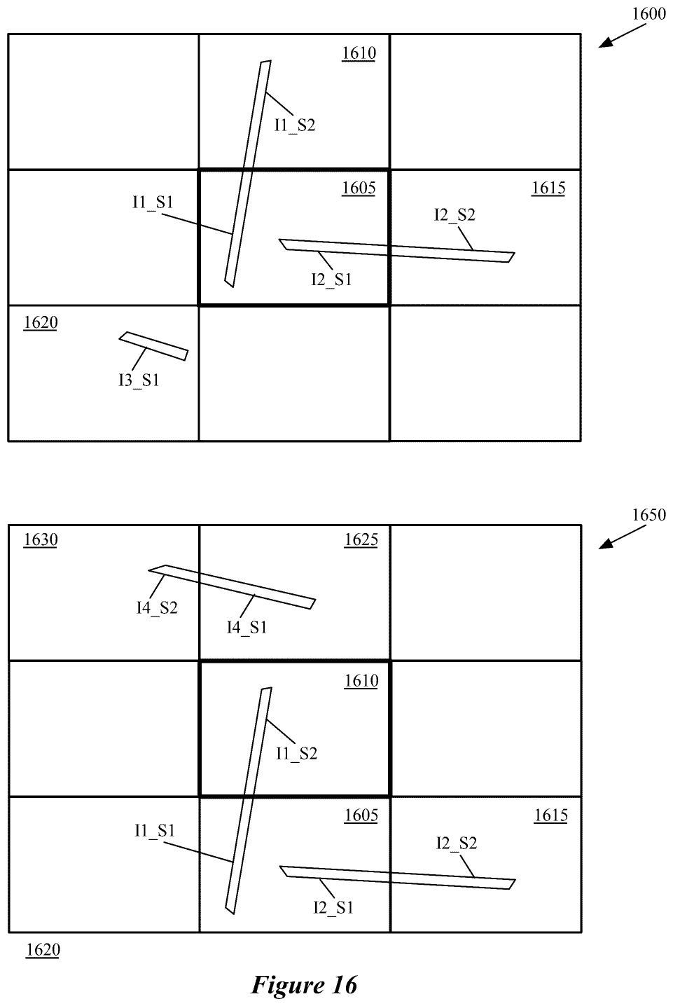

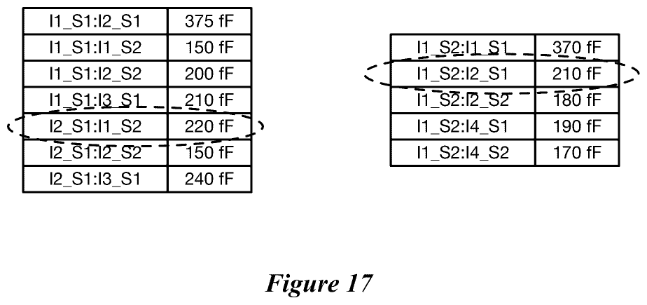

FIGS. 16 and 17 conceptually illustrate an example of this averaging of the capacitance values. FIG. 16 conceptually illustrates a first set of tiles 1600 within a design layout region in which a first tile 1605 is the halo (selected) tile and a second set of tiles 1650 in which a second tile 1610 is the halo (selected) tile and the first tile 1605 is one of the neighboring tiles. The first set of tiles 1600 includes three interconnects (I1-I3). Interconnect I1 includes two segments, I1_SI within the first tile 1605 and I1_S2 within the second tile 1610. Interconnect I2 also includes two segments, I2_S1 within the first tile 1605 and I2_S2 within a third tile 1615. I3 only has one segment, I3_S1, and is entirely contained within a fourth tile 1620. The second set of tiles 1650 also includes three interconnects, I1, I2, and I4. Interconnect I4 includes two segments, I4_S1 within a fifth tile 1625 and I4_S2 within a sixth tile 1630.

FIG. 17 illustrates example capacitive coupling values computed for the interconnects S1-S4, in two tables 1700 and 1750 that correspond respectively to the two sets of tiles 1600 and 1650. These tables 1700 and 1750 show capacitive coupling values between each halo tile interconnect segment (I1_S1 and I2_S1 for the first set of tiles 1600 and only I1_S2 for the second set of tiles 1650) and each other interconnect segment in the respective set of tiles. Thus, the table 1700 includes a capacitive coupling value (375 fF) between the two halo tile interconnect segments as well as three additional values for each of the halo tile interconnect segments. The table 1750 includes five total capacitive coupling values, between segment I1_S2 and each of the five other interconnect segments within the set of tiles 1650.

Each of the tables 1700 and 1750 includes a capacitive coupling between interconnect segment I2_S1 and interconnect segment I1_S2. In practice, there is only one capacitive coupling value between these two segments, but due to the other segments included in each set of tiles (i.e., interconnects I3 and I4), the two computations arrive at two different values for this capacitive coupling value (220 fF compared to 210 fF). As such, some embodiments compute the average of these two values and use 215 fF as the capacitive coupling between the two interconnect segments. Similar averaging is performed for the other values (other than the coupling between I1_S1 and I2_S1) once computations are performed for all of the sets of tiles.

Returning to FIG. 15, the process 1500 then computes the total self-capacitance value for each interconnect. It should be understood that the process 1500 is a conceptual process and that the layout verification tool does not necessarily compute all of the self-capacitances for the IC design region prior to computing all of the capacitive coupling values. In different embodiments, the self-capacitance values and capacitive coupling values may be computed in parallel, serially for one interconnect at a time, etc. Some embodiments compute the capacitive coupling values first and then compute the self-capacitances based on the capacitive coupling values. Similarly, while this figure shows the self-capacitance for each interconnect and the capacitive coupling for each interconnect pair being computed serially one at a time, it should be understood that some embodiments parallelize each of these operations. Still other embodiments compute the capacitance values for the interconnects as an ongoing process while iterating across the IC design region. For instance, some embodiments apply the capacitance values for interconnect segments (and segment pairs) to their respective interconnects (and interconnect pairs) as the capacitance values are calculated. In this case, for pairs of interconnect segments for which the capacitance values need to be averaged, some embodiments wait until both values (and thus the average) have been computed in order to apply these capacitance values to their respective interconnects or interconnect pairs.

As shown, to compute the self-capacitance, the process 1500 selects (at 1515) one of the interconnects. Different embodiments may select the interconnects in different orders based on, e.g., the location of the interconnects within the IC design region. In addition, as mentioned, some embodiments compute the self-capacitances for multiple interconnects in parallel rather than serially.

For the selected interconnect, the process 1500 adds (at 1520) the self-capacitance computed for each segment to the total self-capacitance of the selected interconnect. As described above, the self-capacitance for each interconnect segment is computed when the tile to which that interconnect segment belongs is the selected tile (center tile of the analyzed region). The layout verification tool uses the data structure mapping interconnect segments to interconnects to identify all of the interconnect segments of a selected interconnect and determines the self-capacitances from the respective capacitance matrices for the tiles in which the interconnect segments are located.

In addition, the process 1500 adds (at 1525) the averaged capacitance values for neighboring interconnect segments of the selected interconnect. That is, each interconnect that spans more than one tile has interconnect segments in neighboring tiles that are technically treated as separate conductors and for which a capacitive coupling value is calculated. In some embodiments, these capacitive coupling values are added to the total self-capacitance for the interconnect. For instance, FIG. 10 illustrates an interconnect with three segments 1026, 1031, and 1037. The total self-capacitance for this interconnect is computed, in some embodiments, by adding together the three self-capacitance values for each of these segments as well as the two capacitive coupling values between (1) segments 1031 and 1026 and (2) segments 1031 and 1037. There is no value computed between segments 1026 and 1037 as these two interconnect segments are not located in neighboring tiles.

In addition, rather than directly computing self-capacitance values for each interconnect, some embodiments determine the self-capacitance values based on all of the pairwise capacitance values for an interconnect (the computation of which is described below by reference to operations 1535-1545). Specifically, in some embodiments, the self-capacitance of an interconnect is defined by adding all of the off-diagonal values in the row or column corresponding to that interconnect in a capacitance matrix for the interconnects (i.e., the various capacitive coupling values affecting the interconnect).

The process 1500 then determines (at 1530) whether additional interconnects remain for which the process needs to compute the total self-capacitance. Once the self-capacitances have been computed for all of the individual interconnects, the process determines the capacitive coupling between pairs of interconnects. As shown, the process 1500 selects (at 1535) a pair of interconnects. In some embodiments, the capacitive coupling is determined for each pair of interconnects that either (1) have interconnect segments located in the same tile or (2) have interconnect segments located in neighboring tiles (or both). To identify the list of interconnect pairs, some embodiments generate a data structure by adding the interconnects for any interconnect segment pair for which a capacitive coupling value is calculated to the data structure (eliminating duplicates as well as interconnect segments from the same interconnect).

For the selected interconnect pair, the process 1500 adds (at 1540) the capacitance values (e.g., capacitive coupling) for the interconnect segment pairs located in the same tile to the total capacitive coupling of the selected interconnect pair. For instance, referring to FIG. 10, in order to begin computing the total capacitance value between (1) the interconnect including segments 1026, 1031, and 1037 and (2) the interconnect including segments 1001, 1021, 1027, 1033, and 1036 (as well as one additional interconnect segment on the right side of the figure), the process would apply the capacitance values computed between (1) segments 1036 and 1037, (2) segments 1031 and 1033, and (3) segments 1026 and 1027 to the total capacitive coupling between the two interconnects.

Next, for the selected interconnect pair, the process 1500 adds (at 1545) the averaged capacitance values (e.g., capacitive coupling) for the interconnect segment pairs located in neighboring tiles to the total capacitive coupling of the selected interconnect pair. For instance, referring to the same two interconnects shown in FIG. 10, these values would include the capacitive coupling computed between (1) segments 1033 and 1037, (2) segments 1001 and 1031, (3) segments 1001 and 1026, as well as many others (10 total values). In some embodiments, the total of these values (from operations 1540 and 1545) is the total capacitive coupling of the interconnect pair.

The process 1500 then determines (at 1550) whether additional interconnect pairs remain for which the process needs to compute the total capacitive coupling. Once the capacitive coupling has been computed for all of the pairs of neighboring interconnects, the process 1500 ends.

As mentioned above, in some embodiments, the parasitic extraction process is performed on a 3D view of the semiconductor design rather than a 2D view as shown in these figures. For simplicity, the figures shown above are limited to a single interconnect layer, and some embodiments perform the parasitic extraction separately for each layer, but multiple interconnect layers are typically present in advanced semiconductors. As such, some embodiments take into account the crossover capacitance between wires on adjacent layers when computing capacitance values for an IC design with multiple interconnect layers. To perform these computations, some embodiments extend the grid-based tiling technique into three dimensions.

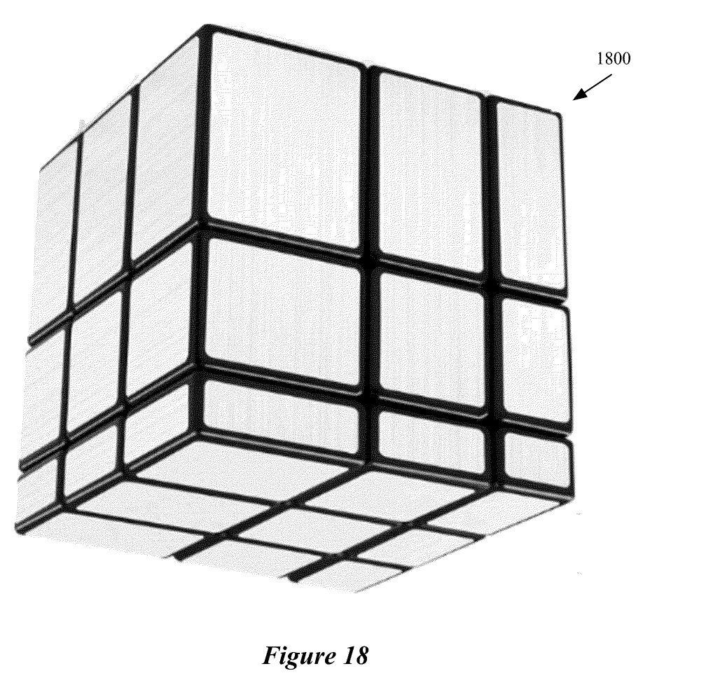

In this case, each selected tile is a rectangular prism (e.g., a cube) rather than a 2D rectangle and has 26 neighboring rectangular prisms rather than 8. FIG. 18 conceptually illustrates such a 3D tiling grid 1800, in this case using differently sized tiles (cells). In some embodiments, each cell belongs to one semiconductor layer (e.g., metal 2), and thus the differently sized cells account for different thicknesses in interlayer dielectrics (those corresponding to higher-level metal layers are often taller than those for lower-level metal layers). Instead of having only eight neighbor cells (in the same metal layer), the 3D grid of cells includes 26 neighbor cells for each selected cell. The selected cell includes nine cells in each of the semiconductor layers above and below and eight cells in the same semiconductor layer.

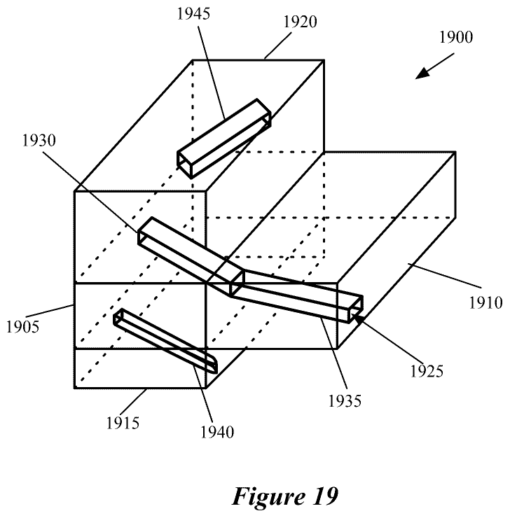

As a more specific example, FIG. 19 conceptually illustrates a set of interconnect segments in a portion of a 3D region 1900. For purposes of simplicity, only a subset of the cells of the 3D region 1900 are shown, in order to adequately illustrate a set of interconnect segments within that 3D region. In this case, the region 1900 includes cells encompassing three metal layers of varying height.

In this specific example, the cell 1905 is the currently selected region, and thus the layout verification tool of some embodiments computes (1) self-capacitance values for the interconnect segments located within the cell 1905, (2) coupling capacitance values between any pairs of interconnect segments located within the cell 1905, and (3) coupling capacitance values between each interconnect segment located within the cell 1905 and each interconnect segment located in any of the surrounding cells (e.g., the 26 surrounding cells, only three of which are shown in this figure for simplicity).

The cell 1905 includes a single interconnect segment 1930 that belongs to an interconnect 1925 that spans at least the cells 1905 and 1910 and includes at least the interconnect segments 1930 and 1935 in these two cells respectively. The cell 1910 borders the cell 1905 and encompasses the same metal layer and interlayer dielectric, while the cell 1915 encompasses a portion of the metal layer below and the cell 1920 encompasses a portion of the metal layer above. As shown, each of the cells 1915 and 1920 include their own interconnect segments 1940 and 1945, respectively.

As such, the layout verification tool of some embodiments, for the selected cell 1905, computes (1) the self-capacitance for the interconnect segment 1930, (2) the coupling capacitance between the interconnect segments 1930 and 1935 (which are part of the same interconnect 1925), (3) the coupling capacitance between the interconnect segments 1930 and 1940, and (4) the coupling capacitance between the interconnect segments 1930 and 1945. The layout verification tool also computes the coupling capacitance between the interconnect segment 1930 and any interconnect segments within any of the other 23 neighboring cells that are not shown in this drawing.

To compute these values, in some embodiments the layout verification tool generates a 3D construction (e.g., as a set of vertices) for the entire region 1900 and provides this set of vertices to an EM field solver for the field solver to output the desired capacitance values. As described above, in other embodiments a set of pixel values is generated for the region. For the 3D region, some embodiments translate the region into voxels (3D counterparts to pixels). Where a pixel represents a value on a grid in a 2D space, a voxel represents a value on a 3D grid. Like pixels, voxels are assigned values (e.g., RGB values if color is used, or values in the range [0,1] for greyscale). To represent a set of interconnect segments in a 3D region, some embodiments represent the voxels within an interconnect by the value 1.0, voxels outside of the interconnects with the value 0.0, and boundary voxels with values between 0 and 1. Some embodiments provide the set of voxels to an MTN to generate the desired capacitance values for the region or use another pixel/voxel-based algorithm to compute the capacitance values. Other embodiments provide the voxels to a field solver that operates on pixels (for a single layer) or voxels (for a 3D region) to compute the capacitances.

As noted, in some embodiments each layer of cells includes both a layer of interconnects that represent wires as well as the interlayer dielectrics either above or below that interconnect layer. Though not shown in this figure, some embodiments also include interconnects representing the z-axis connections (e.g., vias between metal layers, contacts between the first metal layer and the device layer) as segments for which parasitics are computed (e.g., capacitance values between two via-interconnect segments or between a via segment and an interconnect segment). Vias, in some embodiments, may traverse multiple layers of the IC (e.g., to connect a wire in a first metal layer to a wire in a third metal layer. In this case, the via-interconnect representing such a via may be divided into multiple via-interconnect segments in neighboring cells along the z-axis. For instance, a via-interconnect that connects interconnect segments 1940 and 1940 would have via-interconnect segments in at least two of cells 1905, 1915, and 1920.

In some embodiments, each layer of 3D tiles includes one metal or device layer and at most one dielectric layer. For instance, in some embodiments each 3D tile includes a region of one metal layer or device layer (defined by a rectangle within the plane of that metal layer) and the dielectric layer above that metal layer (if such a dielectric layer is part of the design, which may not be the case for the topmost metal layer). In other embodiments each 3D tile includes a region of one metal layer or device layer and the dielectric layer below that layer (which may not be the case for the device layer). In the former case, via-interconnect segments that connect interconnect segments of the metal layer (or device layer) to higher metal layers are included within the 3D tiles, while in the latter case, via-interconnect segments that connect interconnect segments of the metal layer to lower metal layers (or to the device layer) are included within the 3D tiles. Still other embodiments include both a portion of the dielectric layer above and a portion of the dielectric layer below the metal layer whose interconnects are associated with a layer of 3D tiles. Yet other embodiments are also possible, such as overlapping 3D tiles that each include multiple dielectric layers and/or multiple metal layers.

The discussion above, at least in the 2D case, primarily relates to the use of constant (e.g., statically determined) tiles for the capacitance analysis. That is, in some embodiments, the tile size is based on the capacitive coupling between interconnects at different distances. Other embodiments, however, dynamically determine the tile size for a layout region. Some such embodiments make this determination, either for an entire layout region or for a sub-region of the layout region, based on the density of interconnect wires within the region. In general, the higher the density of interconnect wires, the smaller the tile size. This ensures that the number of interconnect segments in a given problem provided to the field solver (or MTN) will not be too large. Furthermore, because of the inverse relationship between distance and capacitance, a first interconnect located a particular distance away from a second interconnect will have a relatively smaller effect on that second interconnect (in relation to the total capacitance on the second interconnect) in a denser region with many interconnects between the first and second interconnect than a third interconnect located the same particular distance from a fourth interconnect will have on that fourth interconnect when there are no intervening interconnects.

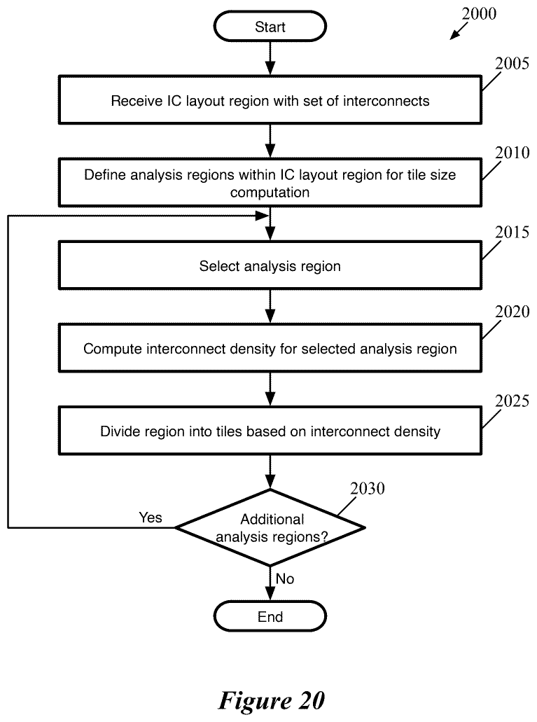

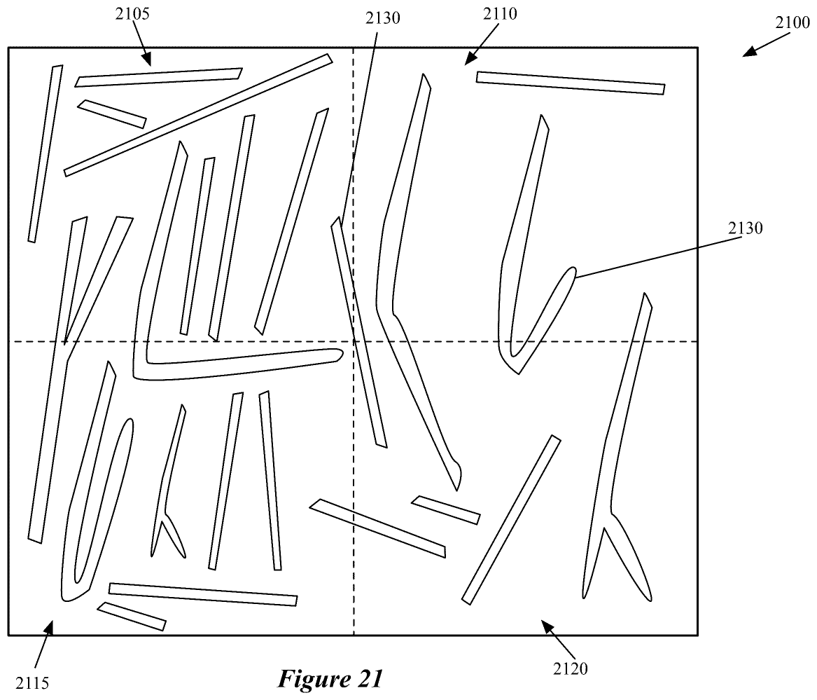

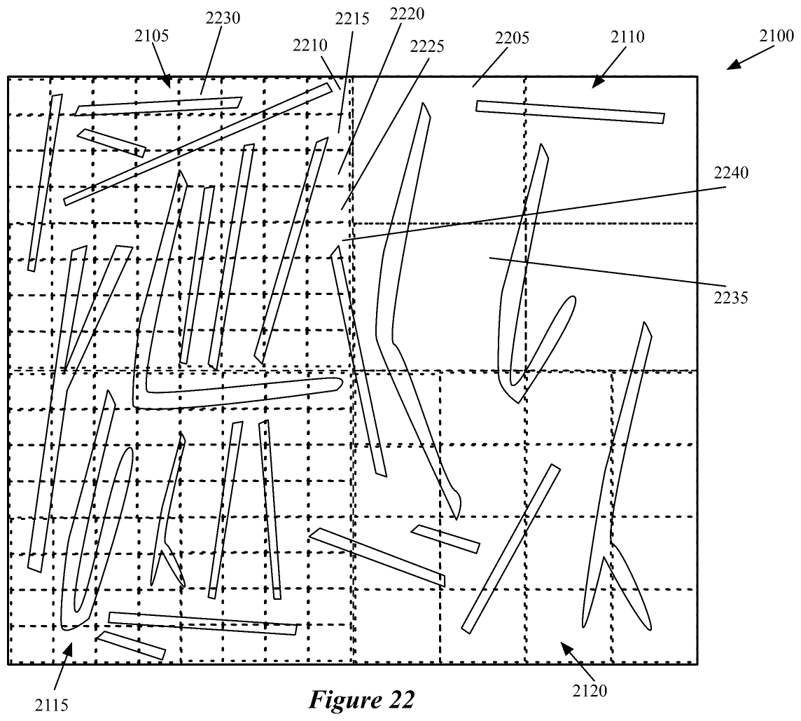

FIG. 20 conceptually illustrates a process 2000 of some embodiments for dynamically determining tile sizes within a region of a design layout. The process 2000 in some embodiments is performed by a layout verification tool that determines whether an IC design layout meets a set of requirements, including parasitic parameter thresholds. In some embodiments, the process 2000 is performed at operation 310 of the process 300 described above, or within a similar process. The process 2000 will be described in part by reference to FIGS. 21 and 22, which illustrate an example of a design layout being divided into differently sized tiles.

As shown, the process 2000 begins by receiving (at 2005) a region of an IC design layout having a set of interconnects. The IC design layout, in some embodiments, is the output of a set of physical design operations that are part of an overall electronic design automation (EDA) process. The semiconductor design region may be an entire IC design (e.g., as shown in FIG. 1) or a smaller portion of such an IC design. The interconnects in the semiconductor design may include any direction of interconnects (e.g., various diagonal directions with neighboring interconnects that are not parallel, perpendicular, or at 45° angles), with or without corner rounding and other curvilinear aspects, and in one or multiple layers of interconnects.

FIG. 21 conceptually illustrates an example of an IC design layout region 2100 with a set of interconnects for a single layer. In this example, the interconnects in the IC design layout region 2100 include curvilinear features and are aligned omni-directionally. That is, the directionality of the interconnects is not limited to any specific direction, and the interconnects can be laid out in any manner in the IC design region.

The process 2000 then determines (at 2010) a set of analysis regions within the IC design layout region for which to perform tile size computation. In some embodiments, a single tile size computation is performed for each IC layout region, while other embodiments divide the IC layout region and compute tile size more granularly (i.e., potentially resulting in different tile sizes for different sub-regions). Some embodiments use a set size (e.g., a number of millimeters in each direction) for each sub-region, while other embodiments divide the IC design layout region into a particular number of analysis sub-regions irrespective of the sub-region size. The size or number of analysis sub-regions may be predetermined for any design layout region or determined specifically for the current design layout region based on user input. FIG. 21 shows that the IC design layout region 2100 is divided into four separate sub-regions 2105-2120 for tile size analysis (shown with dashed lines).

Next, the process 2000 selects (at 2015) one of these analysis regions for which to perform tile size analysis. It should be understood that the process 2000 is a conceptual process and that some embodiments do not necessarily individually select and analyze each sub-region one sub-region at a time. Rather, some embodiments analyze multiple sub-regions in parallel.

The process 2000 then computes (at 2020) the interconnect density for the selected analysis sub-region. Different embodiments may calculate the interconnect density in different manners. Some embodiments determine the number of different interconnects present within the sub-region, irrespective of how much of any given interconnect is fully present within the sub-region. Thus, for example, the sub-region 2105 includes portions of ten different interconnects, while the sub-region 2110 includes portions of five different interconnects. Some embodiments remove interconnect segments below a certain size (e.g., total area) from the count. For instance, some such embodiments would identify the sub-region 2110 as only including four different interconnects based on the segment of the interconnect 2125 that is primarily contained within sub-regions 2105 and 2120 not having enough area within the sub-region 2110 to count. Some embodiments count the total number of separate interconnect segments within the region. Using such a method, the interconnect 2130 would count twice for the sub-region 2110

Other embodiments calculate the interconnect density of a sub-region based on the total area covered by interconnects within the sub-region. In these calculations, having only a segment of an interconnect within the sub-region means that only that segment of the interconnect counts towards the total interconnect density, and thus even very small interconnect segments are used in the calculation. Yet other embodiments may use other measures of interconnect density or other variations on the methods described here.

Based on the calculated interconnect density, the process 2000 divides (at 2025) the analysis region into tiles. In some embodiments, each sub-region has equally sized tiles, but the different sub-regions may have different tile sizes. In general, the layout verification tool uses smaller tiles as the interconnect density increases. Some embodiments directly correlate the interconnect density with the number of tiles in a sub-region. For instance, some embodiments compute the tile size such that the number of interconnects per tile matches (or comes close to matching) a desired value. Other embodiments compute the tile size such that each tile in the sub-region has, on average, a desired area covered by interconnects. In either case, as the number of interconnects or area covered by interconnects increases within a sub-region, the tile size decreases. Some embodiments choose from a set of tile size options (e.g., three or four different tile sizes) based on the interconnect density, still following the premise that denser regions will have smaller tiles.

FIG. 22 conceptually illustrates the tiling for the four sub-regions 2105-2120 of the IC design layout region 2200. As shown, the top-right sub-region 2110 has the largest tiles, the bottom-right sub-region 2120 has intermediately sized tiles, and the two left sub-regions 2105 and 2115 have the smallest tiles. These sub-regions can then be used to perform the capacitance extraction calculations described above.

The process 2000 then determines (at 2030) whether additional regions remain for analysis. If additional regions remain, the process returns to 2015 to select the next sub-region and divide that sub-region into tiles. Once all of the sub-regions have been divided into tiles, the process 2000 ends.

Performing capacitance extraction within a sub-region that has equally sized tiles works in the same manner as described above by reference to FIG. 3 in some embodiments. However, when an IC design layout region has differently sized tiles, different embodiments handle the border calculations differently. For instance, as shown in FIG. 22, a tile of a first size will border one or more tiles of a different size (e.g., the large tile 2205 bounding the smaller tiles 2210-2225).

Some embodiments, much like adding padding tiles around border tiles, use padding tiles on the boundary that equal the size of the selected tile for a given computation. Thus, when the tile 2205 is selected, numerous tiles (including tiles 2210-2225) will be included in the neighboring region. Specifically, the neighboring tile to the left of selected tile 2205 will have 16 of the smaller tiles, as will the tile to the bottom-left of selected tile 2205. In this case, however, rather than recalculating the interconnect segments based on the larger tile size of region 2110, some embodiments use the interconnect segments already defined for the smaller tiles when formulating the problem to provide to the field solver. Thus, in this example, the interconnect segment 2230 would have two different interconnect segments within the neighboring tile to the left of selected tile 2205. Other embodiments, however, only use the actual smaller tiles that bound the larger selected tile as neighboring tiles for that selected tile (i.e., tiles 2210-2225 and 2240 as boundary tiles for selected tile 2205).

When a smaller tile on the boundary is selected, some embodiments use the entire larger tile as a neighboring tile. For instance, when the tile 2225 is selected, some embodiments use the entirety of larger tiles 2205 and 2235 as boundary tiles (in addition to five tiles the same size as the selected tile 2225). Other embodiments use only the portions of the larger tiles that equal the selected tile in size (i.e., two such portions of the tile 2205 and one portion of the tile 2235). In the latter case, if an interconnect segment intersects that smaller tile portion, some embodiments will use the entire interconnect segment as defined for the larger tile when formulating the problem for the field solver in order to keep the use of interconnect segments consistent across the different sub-regions.

It should be noted that the discussion above relates primarily to using tiles (of either equal size or varying size) in which each tile can serve as either a selected (“center” or “core”) tile and as a neighboring (“halo”) tile. Other embodiments divide the design layout region into a grid of core tiles having a first size, then for each selected core tile define neighboring tile regions having a different size or sizes than the core tiles. If, for example, narrower rectangular tiles are used for the four neighboring tiles directly abutting each side of the core tile (i.e., directly above, below, to the left, and to the right), then the four corner neighboring tiles will be square but smaller than the core tile.

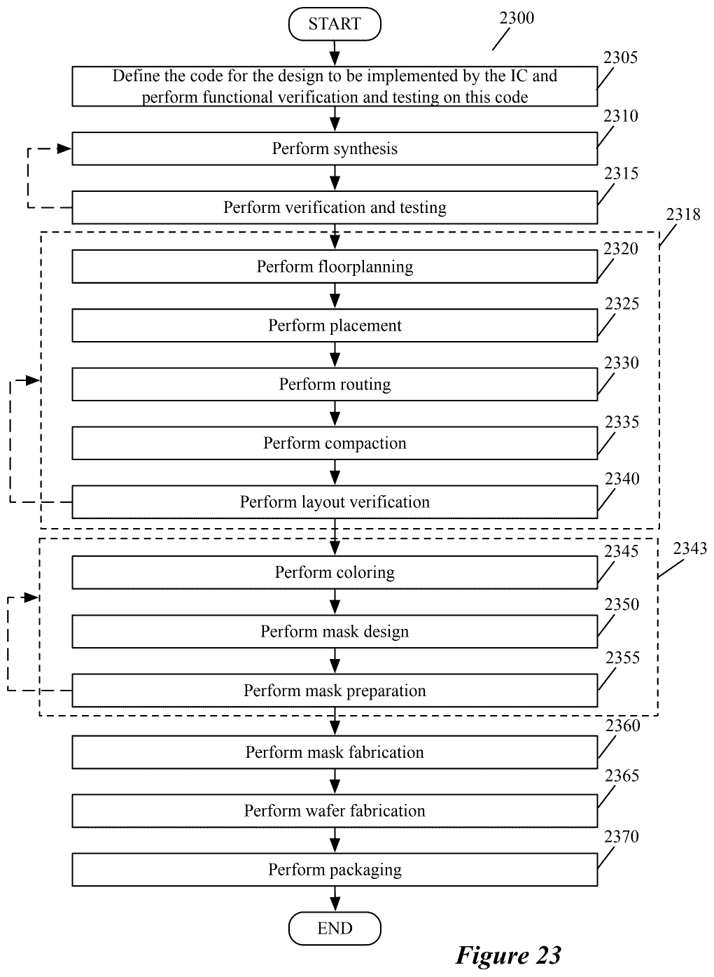

The above-described embodiments describe using a tile-based technique to determine capacitance values for an IC design region. The calculation of these parasitic parameters is one step in the overall process to design and manufacture an IC. FIG. 23 conceptually illustrates an example of one such process for designing and manufacturing an IC. The process 2300 of this figure uses the parasitic extraction techniques described above to ensure that the IC design layouts produced by the process do not violate one or more parasitic parameter thresholds.

The process 2300 begins (at 2305) by defining the code that specifies the IC design and performing functional verification and testing on this code. In some embodiments, the process uses one of the common hardware description languages (HDL) to specify the code. The HDL code in some embodiments describes the desired structure, behavior, and timing of the IC. To perform functional verification and testing on the code for the IC, some embodiments specify one or more modules and/or circuit components in the code and check the specified modules and/or circuit components for functional accuracy.

Next, the process 2300 performs (at 2310) a synthesis operation, which converts the HDL description into a circuit representation that commonly includes digital circuit components, such as logic gates, flip-flops, and other larger digital components (e.g., adders, multipliers, etc.). The synthesis operation is typically performed by a synthesis tool.

At 2315, the process 2300 performs verification and testing on the circuit representation that is produced by the synthesis operation. In some embodiments, the verification and testing checks the circuit representation to determine whether this representation meets desired timing constraints and satisfies any other constraint of the HDL code. When the verification and testing fails (e.g., if a portion of the circuit representation fails to meet a constraint), the process 2300 returns to step 2310 (as denoted by a dashed arrow line) to reperform synthesis to modify the circuit representation to resolve this failure.

When the verification and testing at 2315 passes, the process 2300 performs a set of physical design operations 2318, which include operations 2320-2335 between which the process 2300 can iterate through multiple times as further described below. At 2320, the process 2300 performs a floorplanning operation that defines a general location for some or all of the circuit blocks (e.g., for various large circuit blocks). For instance, in some embodiments, floorplanning divides the design layout into one or more sections devoted to different purposes (e.g., ALU, memory, decoding, etc.), and assigns some or all of the circuit blocks to these sections based on the purposes served by these blocks.

At 2325, the process 2300 performs a placement operation, which is based on the floorplanning data and defines a specific location and orientation in the design layout for each circuit block. The placement operation in some embodiments is an automated process that tries to find an optimal placement for each circuit block based on one or more optimization criteria, such as congestion or estimated length of interconnects (e.g., metal wires) needed for connecting the nets associated with the circuit blocks. A net in some embodiments includes a set of two or more pins of one or more circuit blocks that need to be connected electrically (e.g., through a set of wires, contacts, and/or vias). After performing the placement operation, the process 2300 might return to the floorplanning operation if it determines that the floorplanning should be revised to improve the result of the placement operation.

Once the placement operation is completed satisfactorily, the process performs (at 2330) a routing operation to define the route needed to connect each net (i.e., to connect each set of pins that needs to be interconnected). Each defined route includes one or more interconnect segments (also called wire segments) that traverse one or more interconnect layers (also called wiring layers), and one or more vias and/or contacts that connect pins and/or wire segments on different wiring layers.

To define the routes, some embodiments divide the routing operation into a global routing operation and a detailed routing operation. For each net, global routing defines a global route that more generally defines the route for the net (e.g., defines a general area in the design layout traversed by the route). For instance, in some embodiments, the global router divides an IC into individual global routing areas, called Gcells. Then, a global route (Groute) is created for each net by listing the global routing areas (the Gcells) that the Groute for the net should pass through.

The detailed routing defines the actual route for each net (e.g., the route that connects the set of pins that forms the net). As mentioned above, each defined route includes one or more interconnect segments that traverse one or more interconnect layers, and one or more vias and/or contacts that connect pins and/or wire segments on different interconnect layers. In performing its detailed routing operation, the detailed router of some embodiments uses the global router's Groute data, e.g., by biasing its detail route search for the net to the Groute regions traversed by the Groute defined by the global router.

During or after the detailed routing operation, the process 2300 performs a design rule check (DRC) operation to ensure that the defined routes do not violate design rules. One example of the design rule check that is done for a route is to ensure that the route is not closer than an acceptable minimum spacing requirement on each layer traversed by the route to another route or another component in the design layout on that layer. Routes that violate minimum spacing constraints can cause undue capacitance and, in some cases, electrical shorts on the IC.

The process 2300 in some embodiments can iterate through the global and detailed routing multiple times to identify better Groutes for some nets in order to improve the detailed routes for these nets or other nets. Also, the process 2300 in some embodiments can return from either of these routing operations to an earlier operation in the EDA flow (e.g., to the placement operation) in order to improve the results of this earlier operation to improve the routes defined by the later routing operation.

After routing, the process 2300 performs (at 2335) compaction operations. In some embodiments, the compaction operation compresses the design layout in one or more directions to decrease the size of the IC die (e.g., to decrease the two-dimensional area of the IC die) that would be manufactured based on the design layout. Reducing the size of the IC improves the performance of the IC in some embodiments. A compacted design layout also lowers costs of the ICs manufactured using the design layout by allowing more ICs to be produced for a given wafer size. The compaction operation is optional in some embodiments (i.e., for some IC designs, compaction is not performed)

After the compaction operation (if performed), the process 2300 performs a layout verification operation (at 2340) to ensure that the compacted design layout (e.g., the compacted routes in this design) to ensure that the layout meets one or more verification criteria. This verification operation includes a DRC operation that ensures that the compacted design layout does not violate design rules. One example of the DRC that is done for a route is to ensure that the route is not closer than an acceptable minimum spacing requirement on each layer traversed by the route to another route or another component in the design layout on that layer. Other examples of the DRC include performing minimum area, minimum width, and maximum curvature of shapes (e.g., routes, pins, contacts, vias, or other components) of items in the design layout, as described above.

The layout verification in some embodiments includes other operations, such as extraction. Extraction in some embodiments computes parasitic values (e.g., parasitic capacitance values or parasitic inductance values) exerted on items (e.g., wire segments) in the design layout. In some embodiments, the extraction operation computes capacitance coefficients for one or more conductive components in the design layout (e.g., for each wire segment of a route, or for the entirety of each route, in the design layout), and uses the capacitance coefficients to compute parasitic influence (e.g., capacitance, resistance, or inductance) on the conductive component(s). In some embodiments, the extraction operations use the iterative tile-based techniques described above to compute these parasitic values, making use of an EM field solver and/or a machine-trained network to compute parasitic values for wire segments in small regions of an IC design layout. It should also be noted that some embodiments perform layout verification operations (e.g., DRC, extraction) prior to performing compaction.

After the compaction operation at 2335 or the subsequent verification operation 2340, the process 2300 in some embodiments can return to an earlier operation in the EDA flow (e.g., to the placement operation, to the global routing operation, or to the detailed routing operation) in order to improve the results of this earlier operation to improve the compacted design defined by the later compaction operation. For instance, when the design is not verified at 2340 (e.g., if a problem with the design is detected during verification), the process 2300 returns to an earlier physical design operation 2320 to 2335 to reperform this physical design operation, and any subsequent physical design operation, for a portion or for the entire design layout. In some embodiments, the design layout that exists after the compaction operation and that passes the subsequent verification operation 2340 on this layout is the end result of the physical design process, is called the physical design layout, and is used as the input to the subsequent operations 2345-2355 that form the manufacturing sub-process of the process 2300.

In some embodiments, the physical design sub-process includes other operations that are not displayed in FIG. 23. These other operations are not displayed for purposes of brevity. Examples of such operations include partitioning, power planning, and clock tree synthesis (CTS). In some embodiments, partitioning divides the design layout into similar-sized subsets and ensures a minimum number of connections between subsections. Power planning defines the power delivery network (PDN) that includes the interconnects for delivery power from the power supply circuit to circuits defined by the IC design layout. CTS in some embodiments defines a clock delivery network for delivering one or more clock signals to circuits defined by the IC design layout. CTS in some embodiments also inserts buffers and/or inverters along the clock signal paths on the clock delivery network in order to balance the load and decrease or eliminate any clock skew or delay.

Once physical design operations 2318 are completed and the design layout is finalized, the process 2300 performs a set of mask production operations 2343, which include operations 2345-2360. These processes collectively produce a set of one or more masks for each layer of the IC based on the design layout which, when used to fabricate the IC, should result in an IC (or multiple ICs) that match the design layout as closely as possible.

At 2345, the process 2300 performs a coloring operation for each layer of the design layout. The coloring operation decomposes the design layout for a layer into multiple (e.g., two, three, etc.) separate layouts for the purpose of mask production by assigning each feature in the layout to one of multiple “colors”. For certain IC design layers, the features (e.g., the routes, pins, contacts, vias, etc.) are packed too closely for the features to be printed on a wafer using a single mask. In some embodiments, the coloring operation identifies an optimal decomposition for a layer by iteratively assigning the features in the layer to different colors (e.g., using a graph coloring algorithm) and scoring the decomposition. In some embodiments, this coloring operation is optional and can be skipped for some or all of the IC layers.

After the coloring operation, the process 2300 performs mask design (at 2350) or mask layout generation. Mask design generates, for each layer of the IC, the layout for one or more masks (i.e., one mask for each color) that will optimally create the shapes defined in the layout during fabrication of the IC. Some embodiments use commonly known techniques, such as OPC (optical proximity correction) and/or ILT (inverse lithography technology) operations. An ILT system, for instance, iteratively defines a potential mask layout, performs lithography simulation to simulate the wafer shapes that would be manufactured using the potential mask layout, compares this simulation to a set of target wafer shapes, and updates the mask layout based on the comparison (the inverse lithography step). After numerous such iterations, the ILT system determines an optimized mask design for a given layout.

During or after the mask design operation, the process 2300 performs a mask rule check (MRC) operation (not shown separately in the figure) to ensure that the shapes defined in the mask layout do not violate MRC rules. Examples of the MRC rules include minimum spacing, minimum width, maximum curvature, and minimum area for shapes in the mask layout.

The process 2300 then performs a mask preparation operation at 2355. In some embodiments, the mask preparation operation 2355 includes operations that prepare a mask writer (e.g., an electron beam mask writer) to fabricate a particular mask based on the mask design, such as mask data preparation (MDP) and Mask Process Correction (MPC). MDP in some embodiments prepares the mask layout for a mask writer. This operation in some embodiments includes “fracturing” the data into trapezoids, rectangles, or triangles.

The MPC operation, in some embodiments, accounts for various physical effects during mask production to “correct” the mask layout such that the fabricated mask will more closely match the mask layout. Because of these physical effects, a mask writer following the specific shapes of the mask design will produce a mask that does not perfectly match that mask design. MPC in some embodiments either geometrically modifies these shapes and/or modifies pixel doses for a mask writer such that the resulting mask shapes will more accurately match the desired shapes of the mask design. MDP may use as input the generated mask layout or the results of MPC. MPC may be performed as part of a fracturing or other MDP operation. Other corrections may also be performed as part of fracturing or other MDP operations. Also, in some embodiments, the mask preparation operation calculates several possible mask images by using charged particle beam simulation. Additional description of the mask design and mask preparation operations is provided in U.S. Pat. No. 8,719,739, entitled “Method and System for Forming Patterns Using Charged Particle Beam Lithography”, which is incorporated herein by reference.

Other embodiments, that do not use MPC to modify the mask shapes or pixel doses for a mask writer in order to produce the desired mask shapes, perform a separate mask simulation operation followed by a wafer simulation operation as a verification of the output of the mask design operation 2350. Mask simulation in this case simulates the production of each mask using the respective generated mask layout, while wafer simulation simulates the resulting wafer shapes based on these simulated masks to verify that the resulting wafer shapes will be close enough to the desired wafer shapes.

In some embodiments, after performing mask preparation and/or simulation (or after performing a mask rule check prior to the mask preparation), the process 2300 can return to an earlier operation in the mask production operations 2343 (e.g., to coloring 2345 or mask design 2350) in order to improve the results of this earlier operation and thereby improve the eventual fabricated mask. Due to the high expenses of fabricating a mask, it is generally desirable to have the mask designs optimized before fabrication. In some embodiments, the process 2300 can iteratively repeat the mask production operations 2343 in order to improve the quality of the overall generated mask or can return to one of the earlier physical design operations 2318, as described above.

Once the mask layout is generated and verified, the process 2300 fabricates (at 2360) the one or more masks specified for all the layers of the IC based on the mask layout. Mask generation transforms each mask image (also referred to as a mask layer, in some embodiments) of the mask layout into one or more lithographic masks in some embodiments. In some embodiments, the MPC operation described above is actually performed within the mask writer as the mask writer fabricates a given mask based on the mask design for that mask (i.e., to modify the mask writer output in order to better produce the desired mask).

Once the masks are generated, the process 2300 performs (at 2365) wafer fabrication, which uses the generated masks to manufacture multiple IC dies on an IC wafer (e.g., a silicon wafer). The masks for the substrate and each wiring layer are used to generate the devices and wiring on the substrate and each wiring layer of each IC die. Each IC die is usually tested. During the testing of the IC dies, if it is determined that the IC has a defect because of its design or its masks, the process 2300 has to return to an earlier operation to improve its design layout, its mask layout, or its mask production operation. Lastly, the process 2300 performs (at 2355) packaging, which places each IC die in one chip package. Packaging in some embodiments includes slicing a wafer into multiple IC dies and placing each die on a substrate, which is then encapsulated to form a chip package. After performing packaging, the process 2300 ends.

Although several embodiments were described above by reference to performing parasitic extraction to compute parasitic parameter values on IC designs used to design and/or manufacture an IC, one of ordinary skill will realize that other embodiments are used to perform parasitic extraction for design layouts that are created for designing and manufacturing silicon interposers (e.g., wiring patterns on silicon interposers).

Still other embodiments are used to design and manufacture other patterns on other types of substrates. For instance, some embodiments use the above-described tile-based parasitic extraction processes to verify the design layouts for designing displays such as flat-panel displays (e.g., monitors, televisions, glasses, etc.) or curved displays (e.g., displays for virtual reality or augmented reality headsets). Such design layouts define patterns of controllable pixels on a display substrate. Still other embodiments use the above-described tile-based parasitic extraction processes to check the design layouts for designing other patterns of other elements for other substrates. Examples of such other substrates include substrates used to manufacture micro-electromechanical (MEMS) and other such similar devices.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

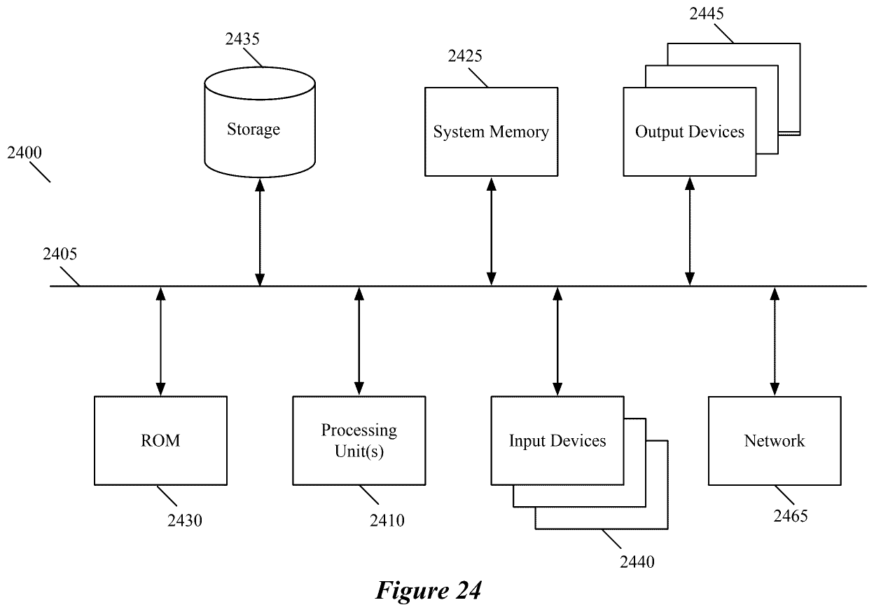

FIG. 24 conceptually illustrates a computer system 2400 with which some embodiments of the invention are implemented. The computer system 2400 can be used to implement any of the above-described computers and servers. As such, it can be used to execute any of the above-described processes. This computer system includes various types of non-transitory machine-readable media and interfaces for various other types of machine-readable media. Computer system 2400 includes a bus 2405, processing unit(s) 2410, a system memory 2425, a read-only memory 2430, a permanent storage device 2435, input devices 2440, and output devices 2445.

The bus 2405 collectively represents all system, peripheral, and chipset buses that communicatively connect the numerous internal devices of the computer system 2400. For instance, the bus 2405 communicatively connects the processing unit(s) 2410 with the read-only memory 2430, the system memory 2425, and the permanent storage device 2435.

From these various memory units, the processing unit(s) 2410 (e.g., CPUs, GPUS, and/or TPUs) retrieve instructions to execute and data to process in order to execute the processes of the invention. The processing unit(s) may be a single processor or a multi-core processor in different embodiments. The read-only-memory (ROM) 2430 stores static data and instructions that are needed by the processing unit(s) 2410 and other modules of the computer system. The permanent storage device 2435, on the other hand, is a read-and-write memory device. This device is a non-volatile memory unit that stores instructions and data even when the computer system 2400 is off. Some embodiments of the invention use a mass-storage device (such as a magnetic or optical disk and its corresponding disk drive) as the permanent storage device 2435.

Other embodiments use a removable storage device (such as a flash drive, etc.) as the permanent storage device. Like the permanent storage device 2435, the system memory 2425 is a read-and-write memory device. However, unlike storage device 2435, the system memory is a volatile read-and-write memory, such a random-access memory. The system memory stores some of the instructions and data that the processor needs at runtime. In some embodiments, the invention's processes are stored in the system memory 2425, the permanent storage device 2435, and/or the read-only memory 2430. From these various memory units, the processing unit(s) 2410 retrieve instructions to execute and data to process in order to execute the processes of some embodiments.

The bus 2405 also connects to the input and output devices 2440 and 2445. The input devices enable the user to communicate information and select commands to the computer system. The input devices 2440 include alphanumeric keyboards and pointing devices (also called “cursor control devices”). The output devices 2445 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 24, bus 2405 also couples computer system 2400 to a network 2465 through a network adapter (not shown). In this manner, the computer can be a part of a network of computers (such as a local area network (“LAN”), a wide area network (“WAN”), or an Intranet, or a network of networks, such as the Internet. Any or all components of computer system 2400 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for calculating parasitic capacitance for an integrated circuit (IC) design layout, the method comprising:
iteratively:
selecting a core region and a plurality of halo regions neighboring the core region; and
for each conductive interconnect segment located in the core region, computing a halo capacitance value representing parasitic capacitance exerted on the interconnect segment by a particular neighboring interconnect segment in a particular neighboring halo region that depends on the particular neighboring interconnect segment in the particular neighboring halo region in addition to at least one additional neighboring interconnect segment in another neighboring halo region; and
to account for first and second interconnect segments in neighboring first and second regions having first and second different computed halo capacitance values with respect to each other due to having different first and second pluralities of neighboring halo regions with different pluralities of interconnect segments, computing a single capacitance value from the first and second computed halo capacitance values and using the single capacitance value to represent the parasitic capacitance exerted by the first interconnect segment on the second interconnect segment and by the second interconnect segment on the first interconnect segment.

2. The method of claim 1, wherein:
each interconnect segment is a part of one interconnect and is located in one region of the design layout;
each interconnect includes at least one interconnect segment in at least one region of the design layout; and
at least a subset of the interconnects include interconnect segments in a plurality of regions of the design layout.

3. The method of claim 2 further comprising using the computed single capacitance values for a plurality of pairs of interconnect segments to determine parasitic capacitances between interconnects to which the interconnect segments belong.

4. The method of claim 3 further comprising using the parasitic capacitances between the interconnects to determine whether to verify the IC design region.

5. The method of claim 1, wherein computing the single capacitance value for the first and second interconnect segments comprises computing a mean of the first and second halo capacitance values.

6. The method of claim 1, wherein:
the first halo capacitance value is computed when the first region is selected as the core region and the second region is one of the plurality of halo regions of the first region; and
the second halo capacitance value is computed when the second region is selected as the core region and the first region is one of the plurality of halo regions of the second region.

7. The method of claim 1, wherein:
a particular region of the design layout has a particular group of neighboring halo regions identified when the particular region is selected as the core region; and
the particular region is identified as a neighboring halo region when each of the regions in the particular group is selected as the core region.

8. The method of claim 1, wherein computing the halo capacitance value for each interconnect segment located in the core region comprises computing a plurality of halo capacitance values for each interconnect segment in the core region, each of the halo capacitance values representing parasitic capacitance exerted on one of the interconnect segments in the core region by one of a plurality of neighboring interconnect segments located in one of the neighboring halo regions.

9. The method of claim 1, wherein the first and second halo capacitance values are different based on an EM field solver accounting for the different pluralities of interconnect segments in the different pluralities of neighboring halo regions.

10. The method of claim 1, wherein the first and second halo capacitance values are different based on providing different pixel-based representations of the different core regions and their respective pluralities of halo regions to a machine-trained network that outputs the halo capacitance values.

11. The method of claim 1, wherein the core region and halo regions are equally-sized for each iteration.

12. A non-transitory machine-readable medium storing a program which when executed by at least one processing unit calculates parasitic capacitance for an integrated circuit (IC) design layout, the program comprising sets of instructions for:
iteratively:
selecting a core region and a plurality of halo regions neighboring the core region; and
for each conductive interconnect segment located in the core region, computing a halo capacitance value representing parasitic capacitance exerted on the interconnect segment by a particular neighboring interconnect segment in a particular neighboring halo region that depends on the particular neighboring interconnect segment in the particular neighboring halo region in addition to at least one additional neighboring interconnect segment in another neighboring halo region; and
to account for first and second interconnect segments in neighboring first and second regions having first and second different computed halo capacitance values with respect to each other due to having different first and second pluralities of neighboring halo regions with different pluralities of interconnect segments, computing a single capacitance value from the first and second computed halo capacitance values and using the single capacitance value to represent the parasitic capacitance exerted by the first interconnect segment on the second interconnect segment and by the second interconnect segment on the first interconnect segment.

13. The non-transitory machine-readable medium of claim 12, wherein:
each interconnect segment is a part of one interconnect and is located in one region of the design layout;
each interconnect includes at least one interconnect segment in at least one region of the design layout; and
at least a subset of the interconnects include interconnect segments in a plurality of regions of the design layout.

14. The non-transitory machine-readable medium of claim 13, wherein the program further comprises a set of instructions for using the computed single capacitance values for a plurality of pairs of interconnect segments to determine parasitic capacitances between interconnects to which the interconnect segments belong.

15. The non-transitory machine-readable medium of claim 12, wherein the set of instructions for computing the single capacitance value for the first and second interconnect segments comprises a set of instructions for computing a mean of the first and second halo capacitance values.

16. The non-transitory machine-readable medium of claim 12, wherein:
the first halo capacitance value is computed when the first region is selected as the core region and the second region is one of the plurality of halo regions of the first region; and
the second halo capacitance value is computed when the second region is selected as the core region and the first region is one of the plurality of halo regions of the second region.

17. The non-transitory machine-readable medium of claim 12, wherein:
a particular region of the design layout has a particular group of neighboring halo regions identified when the particular region is selected as the core region; and
the particular region is identified as a neighboring halo region when each of the regions in the particular group is selected as the core region.

18. The non-transitory machine-readable medium of claim 12, wherein the set of instructions for computing the halo capacitance value for each interconnect segment located in the core region comprises a set of instructions for computing a plurality of halo capacitance values for each interconnect segment in the core region, each of the halo capacitance values representing parasitic capacitance exerted on one of the interconnect segments in the core region by one of a plurality of neighboring interconnect segments located in one of the neighboring halo regions.

19. The non-transitory machine-readable medium of claim 12, wherein the first and second halo capacitance values are different based on an EM field solver accounting for the different pluralities of interconnect segments in the different pluralities of neighboring halo regions.

20. The non-transitory machine-readable medium of claim 12, wherein the first and second halo capacitance values are different based on providing different pixel-based representations of the different core regions and their respective pluralities of halo regions to a machine-trained network that outputs the halo capacitance values.
